(19) United States
(12) Patent Application Publication
(10) Pub. No.: US 2024/0427851 A1
(43) Pub. Date: Dec. 26, 2024

(54) INFORMATION PROCESSING APPARATUS, INFORMATION PROCESSING METHOD, AND INFORMATION PROCESSING PROGRAM

(71) Applicant: Sony Group Corporation, Tokyo (JP)

(72) Inventors: Yoshiya ASAUMI, Tokyo (JP); Shinya MARUYAMA, Kanagawa (JP); Taizo SHIRAI, Kanagawa (JP); Masatomo KURATA, Tokyo (JP)

(73) Assignee: Sony Group Corporation, Tokyo (JP)

(21) Appl. No.: 18/684,851

(22) PCT Filed: Mar. 8, 2022
(86) PCT No.: PCT/JP2022/009882

§ 371 Date: Feb. 20, 2024

(30) Foreign Application Priority Data
Sep. 6, 2021 (JP) 2021-144860

(51) Int. Cl. G06F 21/10

(52) U.S. Cl. CPC G06F 21/1015

(57) ABSTRACT

An information processing apparatus (100) according to the present disclosure includes: an acquisition unit (131) that acquires rights information pre-assigned to first content; and an assignment unit (134) that performs, in a case where second content has been produced by partially using the first content, assignment of rights information related to the second content based on the rights information acquired by the acquisition unit.

### FIELD

The present disclosure relates to an information processing apparatus, an information processing method, and an information processing program, related to music production.

### BACKGROUND

In recent years, with the spread of the Internet and composition tools such as a digital audio workstation (DAW), there is an increasing number of creators who perform a series of works from composition to distribution by themselves. For example, in the fields of dance music and hip hop music, there are many productions of pieces of secondary creation content such as content obtained by sampling existing music to create new music.

Regarding sampling of music, there is known a technique of analyzing existing music using a model trained by a neural network and separating an audio source for individual parts of musical instruments or the like constituting the music, such as vocals or drums (for example, Patent Literature 1).

### CITATION LIST

### Patent Literature

Patent Literature 1: WO 2018/047643 A

### SUMMARY

### Technical Problem

The technique in the literature is useful for music production, for example, in that it is possible to extract only an audio source of a musical instrument necessary for music to be used for sampling by a creator.

On the other hand, handling the extracted audio source by the creator includes complicated labors. For example, the creator needs to take the extracted audio source into the DAW, manage the copyright information related to each extracted audio source, and manually input the copyright information related to the music produced by the creator. Such work might hinder smooth music production.

In view of this, the present disclosure proposes an information processing apparatus, an information processing method, and an information processing program capable of efficiently performing music production and management.

### Solution to Problem

In order to solve the above problems, an information processing apparatus to an embodiment of the present disclosure includes an acquisition unit that acquires rights information pre-assigned to first content, and an assignment unit that performs, in a case where second content has been produced by partially using the first content, assignment of rights information related to the second content based on the rights information acquired by the acquisition unit.

### BRIEF DESCRIPTION OF DRAWINGS

FIG. 1 is an information processing system outline diagram (1) according to an embodiment.

FIG. 2 is an information processing system outline diagram (2) according to an embodiment.

FIG. 3 is a diagram illustrating an outline of audio source separation processing according to the embodiment.

FIG. 4 is a user interface diagram (1) according to the embodiment.

FIG. 5 is a user interface diagram (2) according to the embodiment.

FIG. 6 is a user interface diagram (3) according to the embodiment.

FIG. 7 is a user interface diagram (4) according to the embodiment.

FIG. 8 is a user interface diagram (5) according to the embodiment.

FIG. 9 is a user interface diagram (6) according to the embodiment.

FIG. 10 is a user interface diagram (7) according to the embodiment.

FIG. 11 is a user interface diagram (8) according to the embodiment.

FIG. 12 is a user interface diagram (9) according to the embodiment.

FIG. 13 is a user interface diagram (10) according to the embodiment.

FIG. 14 is a diagram illustrating a configuration example of an information processing apparatus according to the embodiment.

FIG. 15 is a diagram illustrating an example of a creator storage unit according to the embodiment.

FIG. 16 is a diagram illustrating an example of an audio source storage unit according to the embodiment.

FIG. 17 is a diagram illustrating a concept of music data according to the embodiment.

FIG. 18 is an information processing procedure flowchart (1) according to the embodiment.

FIG. 19 is an information processing procedure flowchart (2) according to the embodiment. FIG. 20 is a sequence diagram illustrating a procedure of the information processing system according to the embodiment.

FIG. 21 is a hardware configuration diagram illustrating an example of a computer that implements functions of the information processing apparatus.

### DESCRIPTION OF EMBODIMENTS

Embodiments of the present disclosure will be described below in detail with reference to the drawings. In each of the following embodiments, the same parts are denoted by the same reference symbols, and a repetitive description thereof will be omitted.

The present disclosure will be described in the following order.
1. Embodiments
1-1. Example of information processing system according to embodiment
1-2. Example of audio source separation processing according to embodiment
1-3. Example of assignment of rights information according to embodiment
1-4. Configuration of information processing apparatus according to embodiment
1-5. Information processing procedure according to embodiment
1-6. Modification of embodiment
1-6-1. Operation as information processing system
1-6-2. Rights information
1-6-3. Production system
2. Other embodiments
3. Effects of information processing apparatus according to present disclosure
4. Hardware configuration

### 1. Embodiments

### 1-1. Example of Information Processing System According To Embodiment

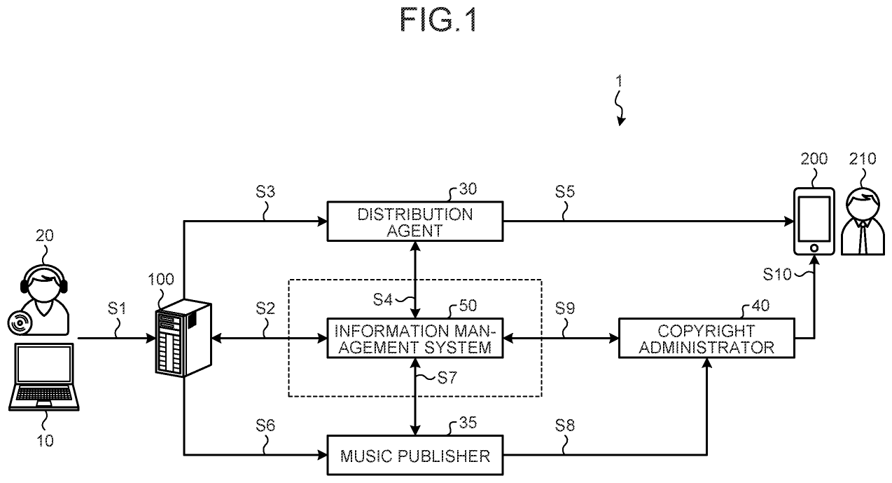

FIG. 1 is a diagram illustrating an outline of an information processing system 1 according to an embodiment.

FIG. 1 is a schematic block diagram illustrating elements (devices and the like) constituting the information processing system 1 and processing executed in the information processing system 1. The information processing system 1 executes various types of information processing related to a digital audio workstation (DAW) provided by an information processing apparatus 100 to a creator 20.

As illustrated in FIG. 1, the information processing system 1 includes a creator terminal 10, a distribution agent 30, a music publisher 35, a copyright administrator 40, an information management system 50, the information processing apparatus 100, and a user terminal 200. These various devices are communicably connected by a wired or wireless connection via a network N (not illustrated, and example of this is the Internet).

The creator terminal 10 is a terminal device used by the creator 20 who creates music on the DAW provided by the information processing apparatus 100. For example, the creator terminal 10 is a personal computer (PC), a smartphone, a tablet terminal, or the like. The creator 20 is not limited to the composer of the music, and may include a person having any right related to the music, such as a lyricist and an arranger. Furthermore, in the description of the present disclosure, the term DAW is used as a program used for music production, but the technology of the present disclosure is not necessarily limited thereto. The DAW in the present disclosure broadly refers to general software and applications used for music production and the like in various devices including a smartphone and a PC, and is a concept including software and the like not referred to as DAW.

In the embodiment, a piece of content to be produced is referred to as a piece of “music”, but the content is not limited to music, and may be video content such as a movie. Furthermore, the content need not be limited to completed content such as a piece of music, and may be some audio sources used for music, short sound used for sampling, and the like. Note that the audio source according to the embodiment is audio data that is an element constituting music, and includes various types of information. For example, the audio source includes data such as tone, pitch, and the speed (tempo) of sound, and is recorded in a recording medium in various file formats that can be handled in information processing. On a DAW, an audio source is typically represented in a waveform. A material of music distributed in a music distribution site, a video distribution site, or the like is also an aspect of the audio source. Furthermore, the audio source can be separated using the existing technology described in the literature above. As an example, audio sources that include a plurality of musical instruments are separable into audio sources for each musical instrument.

The distribution agent 30 represents an agent of the distribution (typically referred to as a distributor or the like) of the music produced on the DAW, and a server or a terminal device used by the agent. For example, the distribution agent is a provider that operates a music sales site or a video distribution site or supplies content to these sites.

The music publisher 35 indicates a business operator that performs business such as copyright management and promotion of music produced by the creator 20, and a server or a terminal device used by the business operator.

The copyright administrator 40 represents an organization that administers the copyright registered from the music publisher 35 in the country, and a server or a terminal device used by the organization. The copyright administrator 40 performs processes such as calculation of a copyright usage fee when music is used, collection of the copyright usage fee, sharing of the copyright usage fee to the music publisher 35, and the like.

The information management system 50 is a system that records various types of information related to music. For example, the information management system 50 is a distributed ledger system referred to as a blockchain in which data is shared by a plurality of nodes. For example, the information management system 50 is a consortium blockchain in which each of the information processing apparatus 100, the distribution agent 30, the music publisher 35, and the copyright administrator 40 is used as a node. Note that each element (generally referred to as an “entity” or the like) constituting the information processing system 1 can use a messaging service that exchanges messages and the like via a network.

The information processing apparatus 100 is a device that executes information processing according to the present disclosure, and an example of this is a cloud server connected to the creator terminal 10 via the Internet. The information processing apparatus 100 provides the creator 20 with the DAW that operates on the creator terminal 10. Furthermore, the information processing apparatus 100 may play a role as a music label that manages music produced by the creator 20.

The user terminal 200 is a terminal device used by an user 210, and examples of this include a PC, a smartphone, and a tablet terminal. In accordance with the operation of the user 210, the user terminal 200 accesses a music distribution site, a video distribution site, or the like to which music is provided via the distribution agent 30, acquires music from the site, and plays the acquired music.

In FIG. 1, each element constituting the information processing system 1 conceptually indicates a function in the information processing system 1, and can take various forms depending on the embodiment. For example, each element constituting the information processing system 1 may be one or two or more terminal devices. Furthermore, each element constituting the information processing system 1 may be a terminal device operated artificially or a program running on the terminal device.

In the example illustrated in FIG. 1, the creator 20 runs the DAW provided by the information processing apparatus 100 on the creator terminal 10 to produce music. Conventionally, various complicated processes have been required to distribute music produced by the creator 20. For example, in producing music, the creator 20 accesses a material providing site that provides a music material and purchases a material to be used for the music. Alternatively, the creator 20 extracts a part of an existing music or apply frequency filtering on the music, and processes the existing music to create a material. Copyright information is set in such a material, and the creator 20 needs to apply to the material providing site, the right holder, or the like for the time length used for the music, the specific portions used, or the like. Furthermore, in a case where a part of the audio source has been extracted from the material using a predetermined filter, the creator 20 needs to convert the audio source into a format that can be handled on the DAW and needs to check whether the extracted audio source can be used for the music according to the rule. In addition, when the creator 20 desires to change the speed (tempo) or the pitch (key) of the material, it takes time and effort to download the material from the material providing site or the like to the creator terminal 10 and edit the material with the DAW.

Furthermore, in a case where the creator 20 desires to distribute the music after producing the music, there is a need to apply for all the materials used for the music for the rights handling. At this time, the creator 20 needs to record a portion of the material used in the music, a utilization time, right holder information of each material, and the like. Since such work is manually performed by the creator 20, it takes time and effort, with the high probability of occurrence of recording errors and the like. That is, conventional music production has many problems for efficiently performing music production and management.

Therefore, the information processing system 1 and the information processing apparatus 100 according to the present disclosure are provided to solve the above problem by the following information processing. Specifically, the information processing apparatus 100 provides the creator 20 with a DAW integrating functions such as processing of separating an audio source from a material and rights handling of produced music. With this configuration, the creator 20 can efficiently perform music production, and can collectively perform rights handling required at the time of distribution, a sharing procedure of a copyright usage fee when own music is used, and the like. Furthermore, according to the DAW and the database provided by the information processing apparatus 100, in a case where the music or material owned by another creator who provides existing music is used, the another creator can appropriately collect the copyright usage fee corresponding to the use.

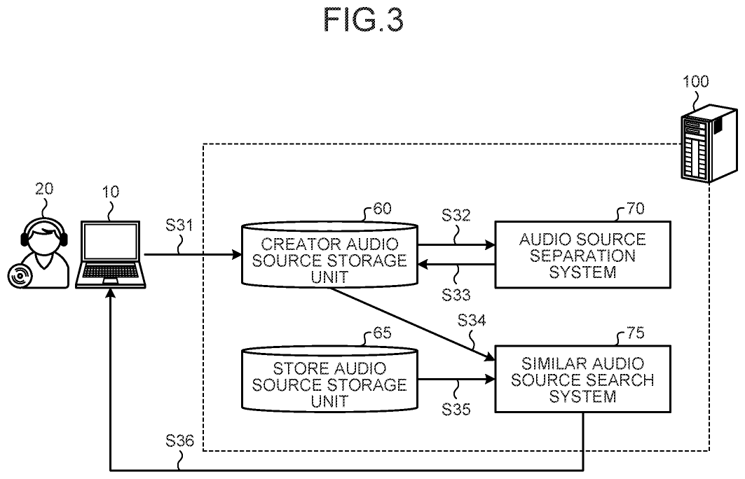

Hereinafter, information processing performed by the information processing system 1 will be described along a flow with reference to FIG. 1. First, the creator 20 creates music on the creator terminal 10 using the DAW which is a cloud application provided from the information processing apparatus 100. The information processing apparatus 100 executes audio source separation processing according to the present disclosure on the creator terminal 10 through the DAW in the process of music production. Furthermore, the information processing apparatus 100 assigns copyright information or the like to music based on the material or the like used by the creator 20. The processing on the DAW will be described in detail below with reference to FIG. 3.

Thereafter, the creator 20 registers the produced music and the rights information related to the music in the information processing apparatus 100 (Step S1). The information processing apparatus 100 registers various types of information such as music, rights information related to the music, and contract information with the creator 20 in the information management system 50 (Step S2).

Note that, in a case where the creator 20 uses existing music, a material distributed in a material distribution site, or the like for production, permission from the right holder of the original music (material) is required for the use. In this case, the information processing apparatus 100 accesses the information management system 50, and acquires rights information registered by the right holder of the original music. Subsequently, the information processing apparatus 100 refers to the rights information, and presents, to the creator 20, conditions (copyright usage fee, permitted use time, and the like) in using existing music and materials. As will be described below, since these pieces of rights information are pre-recorded in the information processing apparatus 100 or the information management system 50, the creator 20 can use these materials by applying for the use of the material on the DAW. In a case where rights of a plurality of persons are related to the music produced by the creator 20, the information processing apparatus 100 acquires rights information from all rights related persons. For example, the information processing apparatus 100 can contact the right holders by messaging or the like on the DAW, perform agreement processing of a contract for use in music, and acquire the rights information from the plurality of persons. This is because metadata of the music produced by the creator 20 includes identification information registered for each material, identification information of the copyright holder, and the like, making it possible for the information processing apparatus 100 to specify the copyright holder.

The information management system 50 manages music information using a blockchain. For example, the information management system 50 writes various procedures and information related to rights such as conditions for the third party's use of music, a utilization contract, and calculation of profit sharing, in a program (referred to as a smart contract) executed in the blockchain. That is, since the creator 20 can register their original music in an immutable blockchain, it is possible to reliably prove that the music is a copyrighted work of the creator.

Furthermore, when having received the registration of the music, the information processing apparatus 100 transmits information related to the music to the distribution agent 30 (Step S3). In other words, the information processing apparatus 100 entrusts the distribution agent 30 with the audio source and the distribution processing of the music as a music label. The distribution agent 30 accesses the information management system 50 and acquires the rights information to be noted at the distribution of the music (Step S4). In addition, the distribution agent 30 writes, in the information management system 50, conditions such as profit sharing in a case where the music is played on a music distribution site or the like. Thereafter, the distribution agent 30 provides the music to the user 210 via a music distribution site, a video distribution site, or the like (Step S5).

Note that the information processing apparatus 100 may present distribution conditions by the distribution agent 30 to the creator 20 at the timing of Step S4. For example, on the DAW, the information processing apparatus 100 presents, to the creator 20, the amount of distribution per piece of music on a predetermined site, the profit shared or revenue per single playback of the music, the rate of copyright usage fee at that time, and the like. The creator 20 may determine whether to entrust the distribution to the distribution agent 30 after confirming the information. When entrustment of the distribution is determined, the distribution agent 30 or the information processing apparatus 100 writes the information in the information management system 50. Since the contract information is written on the blockchain, the creator 20 can prevent situations such as falsification or tampering of the contract. In addition, the creator 20 can simultaneously check the distribution conditions on the DAW used for registration of the music and application for distribution. The information processing apparatus 100 provides the creator 20 with the DAW capable of integrally managing procedures from the music production to the distribution, making is possible to support the production activity of the creator 20.

When having received the registration of the music, the information processing apparatus 100 transmits copyright information related to the music to the music publisher 35 (Step S6). In other words, the information processing apparatus 100 transfers the copyright related to the music to the music publisher 35. The music publisher 35 writes information related to the transferred copyright in the information management system 50 (Step S7). For example, the music publisher 35 writes, in the information management system 50, information such as the person set as a copyright holder for the music and the predetermined share when the shared profit is obtained from the copyright administrator 40. In addition, based on laws and regulations of each country, the music publisher 35 applies for copyright information to the copyright administrator 40, which is a predetermined association that administers copyright (Step S8). Normally, in a case where the music publisher 35 or the like applies for the copyright information to the copyright administrator 40, it is necessary to handwrite the information in a procedure document or the like, leading to a possibility of increased personnel, increased time to complete the application, or occurrence of missed sections at the writing. In contrast, with the information processing according to the embodiment that uses the copyright information automatically pre-assigned to the music by the DAW, it is possible to reduce the time and effort required for the processing and to prevent registration of erroneous information.

The copyright administrator 40 writes the copyright information acquired from the music publisher 35 in the information management system 50 (Step S9). For example, the copyright administrator 40 writes information such as a scene or a condition permitted regarding the use of the music, and the amount of the copyright fee or the like to be paid to the copyright administrator 40 when the viewing/listening or public transmission of the music is performed. In this manner, individual entities constituting the information processing system 1 manage and update the information related to the blockchain, thereby constructing music-related information, which is immutable and trackable. Furthermore, the copyright administrator 40 provides information such as conditions for the use of the music by the user 210 to the user 210 via a predetermined site or the like (Step S10). In other words, the copyright administrator 40 grant a use permission of music to a music distribution site or the like accessed by the user 210.

These processes make it possible for the user 210 to perform viewing/listening of the music produced by the creator 20.

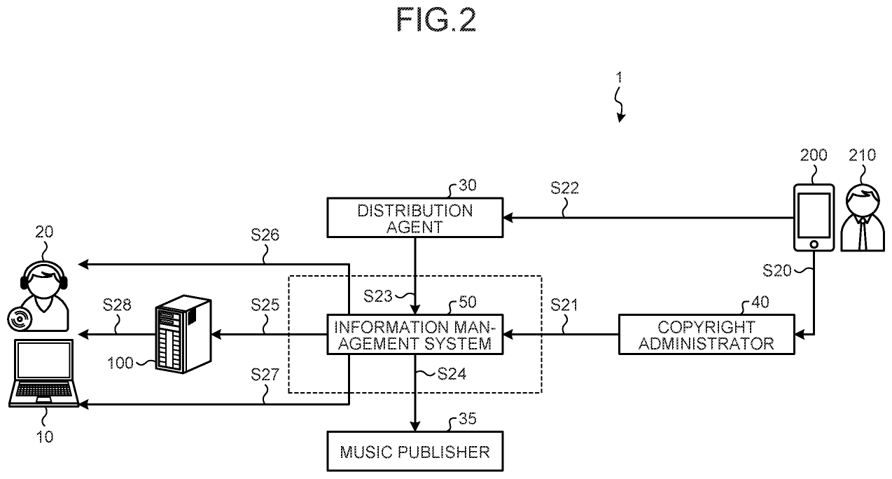

Next, a flow of utilization fee handling and the like in a case where music produced by the creator 20 is used will be described with reference to FIG. 2. FIG. 2 is an information processing system 1 outline diagram (2) according to the embodiment.

In FIG. 2, in a case where the user 210 uses certain music, information indicating that the music has been used is transmitted from the user terminal 200 to a music distribution site or the like. The music distribution site or the like sends a usage report regarding the music and pays the copyright usage fee to the copyright administrator 40 (Step S20). The copyright administrator 40 registers the usage report received from the music distribution site or the like and the information related to the collected copyright usage fee in the information management system 50 (Step S21).

Furthermore, the music distribution site or the like sends a distribution report such as the number of times and duration of distribution of the music and pays a master recording usage fee to the distribution agent 30 (Step S22). The distribution agent 30 registers, in the information management system 50, the distribution report received from the music distribution site or the like and the information related to the collected master recording usage fee (Step S23).

The information management system 50 performs re-sharing of the collected copyright usage fee to the music publisher 35 based on the copyright information set to the music (Step S24). Furthermore, the information management system 50 sends to the music publisher 35 a report indicating the details of the use of the music. Note that such processing may be performed by an administrator of the information management system 50 (for example, an administrator of the information processing apparatus 100), or may be performed according to a program described in advance as a smart contract. For example, in a case where there is a copyright usage fee or a usage report, the information processing apparatus 100 describes, as a smart contract, that a re-sharing process is to be performed on the music publisher 35 on a preset date, whereby the above processing is automatically executed.

In addition, the information management system 50 reports the copyright usage fee, the master recording usage fee, which have been paid for the music, the distribution information, and the like to the information processing apparatus 100 (Step S25). In addition, the information management system 50 pays the master recording royalties related to the shared master recording usage fee to the creator 20 (Step S26). Furthermore, the information management system 50 pays the copyright license royalties related to the shared copyright usage fee to the creator 20 (Step S27). The processing executed by the information management system 50 may be automatically executed based on the smart contract similarly to Step S24. Note that the master recording royalties and the copyright royalties may be assigned to the creator 20 or another copyright holder (such as the copyright holder of the material used in the music) in a form of a token that can be transmitted on the blockchain.

As described above, according to the information processing system 1, it is possible to assign copyright information such as a copyright to music using the function of the DAW provided by the information processing apparatus 100. Furthermore, by centrally managing rights related to music using a blockchain such as the information management system 50, the information processing system 1 can smoothly execute operations such as registration of rights and sharing of utilization fees.

The outline of the processing according to the information processing system 1 has been described above with reference to FIGS. 1 and 2. Next, information processing related to the DAW provided by the information processing apparatus 100 will be described in detail with reference to FIG. 3 and subsequent drawings.

### 1-2. Example of Audio Source Separation Processing According to Embodiment

As described above, the DAW provided by the information processing apparatus 100 has various functions that can be used when the creator 20 creates music. Hereinafter, audio source separation as an example of the function will be described.

FIG. 3 is a diagram illustrating an outline of audio source separation processing according to the embodiment. FIG. 3 is a schematic block diagram illustrating a flow of processing when the information processing apparatus 100 performs audio source separation.

When the creator 20 requests execution of audio source separation on the DAW, the creator terminal 10 accesses a creator audio source storage unit 60 included in the information processing apparatus 100 (Step S31). The creator audio source storage unit 60 stores music data being produced by the creator 20, audio sources produced by the creator 20 in the past, audio sources and materials purchased in the past, and the like.

The creator 20 selects an audio source to undergo audio source separation among audio sources stored in the creator audio source storage unit 60. The information processing apparatus 100 sends the selected audio source to an audio source separation system 70 (Step S32).

The audio source separation system 70 has a function of separating a predetermined sound from an original audio source as a separation target in accordance with a request from the creator 20. For example, the audio source separation system 70 is a plug-in that works on a DAW. The audio source separation system 70 uses the information processing apparatus 100 to execute audio source separation following a request from the creator 20. For example, in a case where the creator 20 requests to separate the sound of a guitar from the audio source, the information processing apparatus 100 generates a guitar audio source separated from the audio source. Then, the information processing apparatus 100 sends the generated guitar audio source to the creator audio source storage unit 60 (Step S33).

Here, in order to search whether an audio source similar to the generated guitar audio source exists in a music distribution store, a material sales store, or the like (hereinafter, collectively referred to as “store”) linked with the DAW, the information processing apparatus 100 sends the guitar audio source to a similar audio source search system 75 (Step S34).

The similar audio source search system 75 has a function of searching for an audio source similar to a target audio source by determining whether the target audio source is similar to any of audio sources. For example, the similar audio source search system 75 is a plug-in that works on a DAW. In the search, the similar audio source search system 75 acquires an audio source from a store audio source storage unit 65 that stores the audio source held by a store (Step S35). In the example of FIG. 3, the information processing apparatus 100 uses the function of the similar audio source search system 75 to search the store audio source storage unit 65 for an audio source similar to the guitar audio source generated by the audio source separation system 70. In a case where a similar audio source has been found by the search, the information processing apparatus 100 sends the search result to the creator terminal 10 (Step S36). The creator 20 can flexibly select an audio source obtained by themselves by using audio source separation or an audio source found by the information processing apparatus 100 and can use the obtained audio source for music production.

In Step S32, the creator 20 may acquire the audio sources stored in the creator audio source storage unit 60, and in addition, may search the store and acquire other audio sources to undergo audio source separation found by the store search. For example, the creator 20 can search for existing music and materials by designating material genre, tempo, BPM, keys, and the like in the search system on the DAW. In this case, in the DAW, the information processing apparatus 100 may provide functions usable by the creator 20, such as a function of performing trial listening of the searched audio source and a function of changing the tempo and/or the key of the audio source. Furthermore, when the creator 20 acquires an audio source to undergo audio source separation, the information processing apparatus 100 may make an inquiry to the information management system 50 to confirm whether the music to be downloaded is truly registered or not.

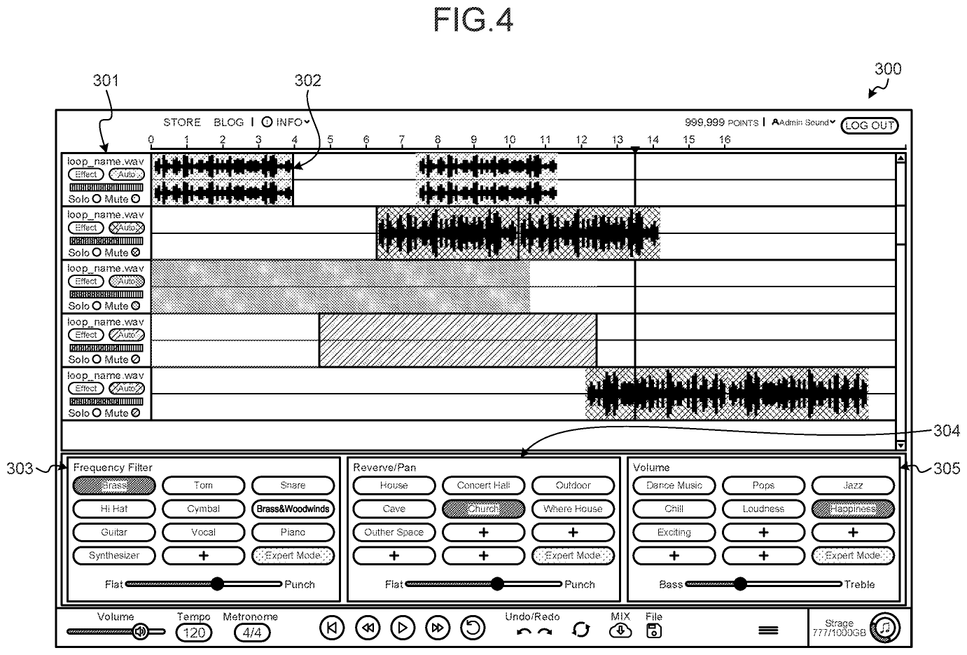

The flow of the processing related to audio source separation has been described above with reference to FIG. 3. Next, an example of a user interface at execution of audio source separation on the DAW will be described with reference to FIG. 4 and subsequent drawings.

FIG. 4 is a user interface diagram (1) according to the embodiment. FIG. 4 illustrates a screen 300 on the DAW and various types of information included in the screen 300.

As illustrated in FIG. 4, the screen 300 includes: a track display 301 indicating each track in music production; and a waveform 302 indicating an audio source included in the track. Furthermore, the screen 300 includes filter information 303 used for editing the audio source, pan information 304 indicating localization for each track, equalizer information 305 for adjusting the frequency of the audio source or the music, and the like. Note that the screen 300 illustrates a typical screen example of a DAW that performs music production for the purpose of describing the embodiment, and the functions and information included in the DAW according to the embodiment are not limited thereto.

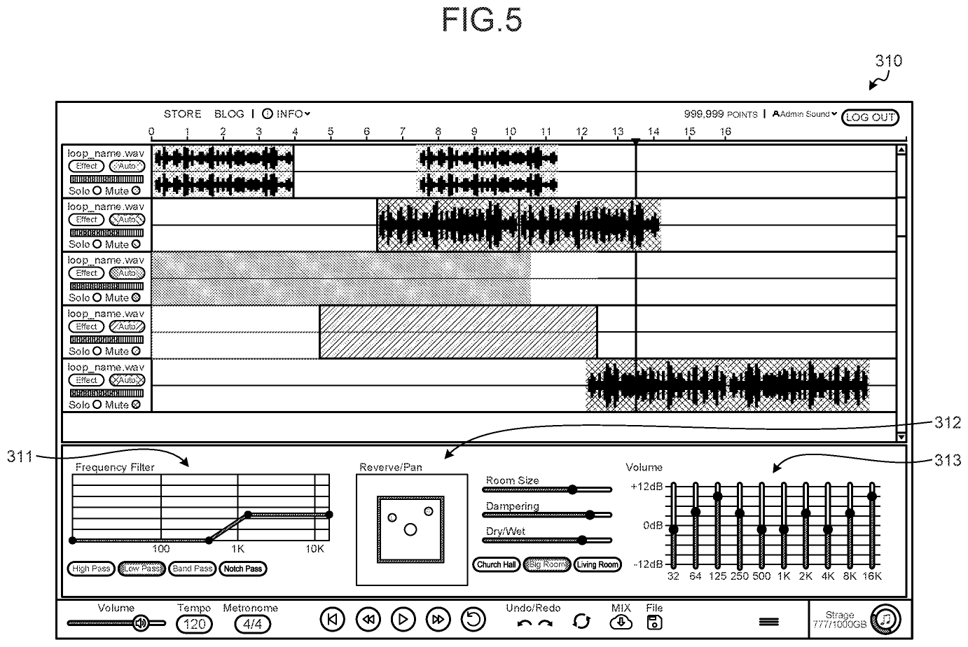

Next, another display example of the functions included in the DAW will be described with reference to FIG. 5. FIG. 5 is a user interface diagram (2) according to the embodiment. FIG. 5 illustrates a screen 310 on the DAW and various types of information included in the screen 310.

As illustrated in FIG. 5, the screen 310 includes filter information 311 indicating the filter information 303 in another display example, pan information 312 indicating the pan information 304 in another display example, and equalizer information 313 indicating the equalizer information 305 in another display example.

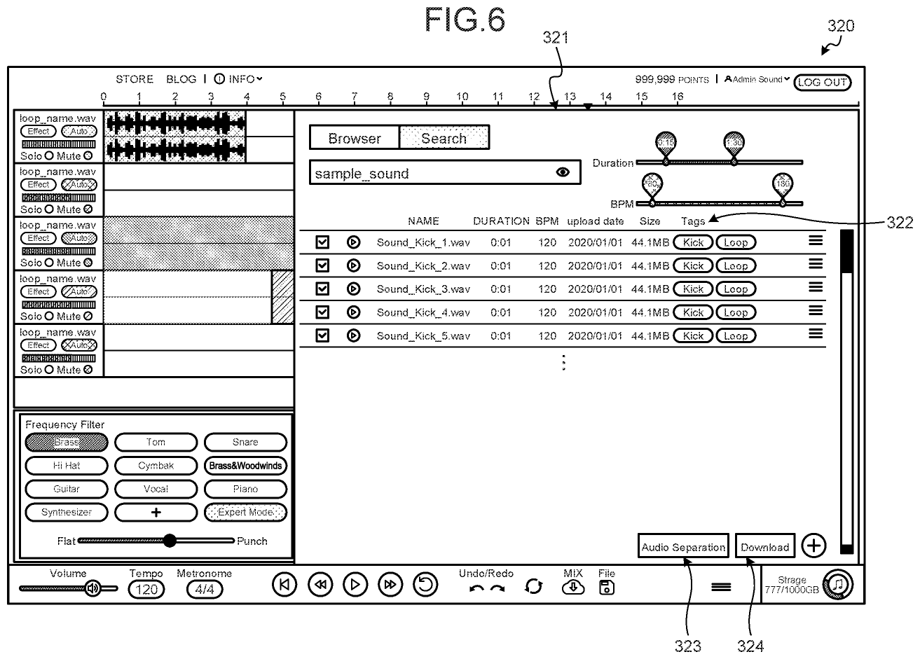

Next, a display example when the DAW executes the audio source separation will be described with reference to FIG. 6. FIG. 6 is a user interface diagram (3) according to the embodiment. FIG. 6 illustrates a screen 320 on the DAW and various types of information included in the screen 320.

When executing the audio source separation, the creator 20 displays a window 321 for displaying a list of audio sources included in the track being produced on the DAW. The window 321 displays a list of audio sources included in each track. For example, the list includes items such as the name of the audio source, the playback time of the audio source, the tempo (represented by Beats Per Minute (BPM) or the like), the date and time of addition to the track, the audio source information including the sampling frequency, and tag information 322 automatically assigned by the analysis of the audio source. The window 321 may include not only the audio source included in the track but also the store audio source searched by the creator 20.

The creator 20 selects a desired audio source and clicks a button 323 on the DAW to command audio source separation. In addition, when it is desired to confirm the audio source or desired to acquire the store audio source, the creator 20 clicks a button 324 and downloads the audio source to the creator terminal 10 which is a local terminal.

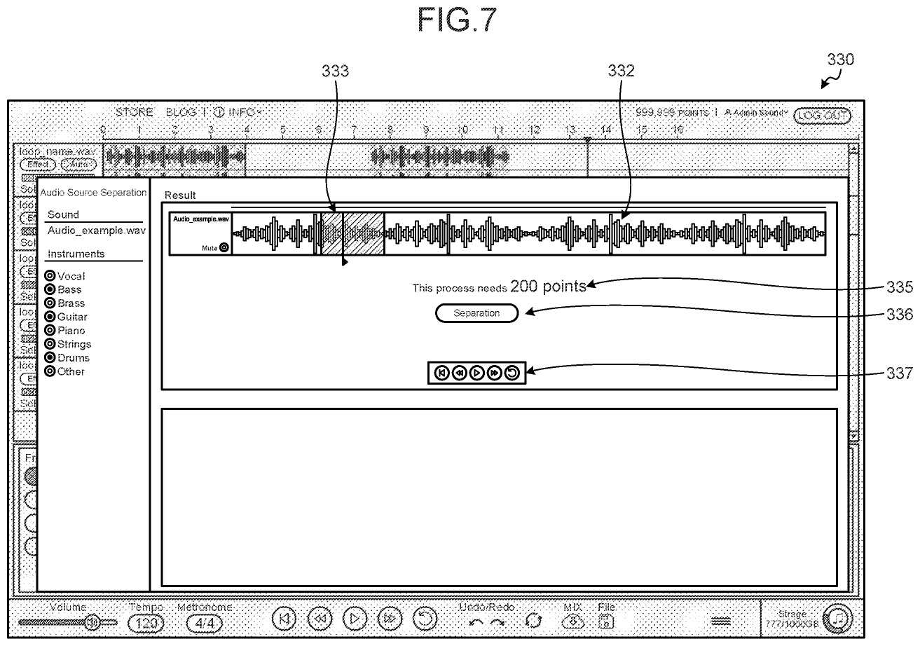

When the button 323 is clicked in FIG. 6, the screen 320 transitions to a screen 330 illustrated in FIG. 7. FIG. 7 is a user interface diagram (4) according to the embodiment. FIG. 7 illustrates the screen 330 on the DAW and various types of information included in the screen 330.

In the example illustrated in FIG. 7, it is assumed that the creator 20 selects an audio source 332 as the audio source to undergo audio source separation. Furthermore, the creator 20 may select a partial portion of the audio sources 332 to actually undergo audio source separation. In the example illustrated in FIG. 7, it is assumed that the creator 20 selects a waveform 333 as a portion to undergo audio source separation.

Subsequently, the creator 20 selects a musical instrument from items 334 to select a musical instrument to undergo audio source separation. For example, in a case where it is desired to separate the sounds of the bass, the guitar, and the drums from the audio sources included in the waveform 333, the creator 20 selects the corresponding buttons.

Here, the information processing apparatus 100 presents information necessary for audio source separation to the creator 20. Examples of the information necessary for the audio source separation include a copyright usage fee to be paid by the creator 20 to the copyright holder of the audio source and a utilization fee preset in the material. In the example of FIG. 7, it is assumed that the information necessary for the audio source separation is indicated by a predetermined point linked with the store. For example, the information processing apparatus 100 calculates points necessary for processing based on the time duration of the waveform 333 and the number of musical instruments to undergo audio source separation. Subsequently, the information processing apparatus 100 displays billing information 335 indicating the calculated points on the screen 330.

After confirming the waveform 333 for audio source separation, the items 334, and the billing information 335, the creator 20 clicks a button 336 according to the desire to execute audio source separation. With these operations, the information processing apparatus 100 executes audio source separation. When it is desired to confirm the details of the audio source 332 and the waveform 333 before executing the audio source separation, the creator 20 can operate an operation panel 337 to perform playback of the audio source 332 and the waveform 333, and the like.

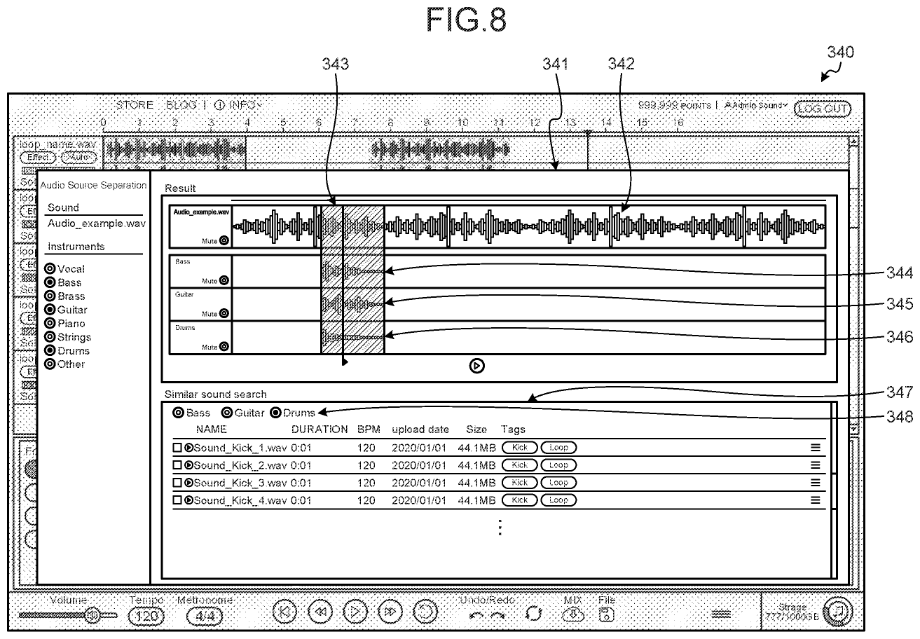

When the button 336 is clicked in FIG. 7, the screen 330 transitions to a screen 340 illustrated in FIG. 8. FIG. 8 is a user interface diagram (5) according to the embodiment. FIG. 8 illustrates the screen 340 on the DAW and various types of information included in the screen 340.

The screen 340 has a window 341. The window 341 displays an audio source 342 to undergo audio source separation and a waveform 343 that is a portion to actually undergo audio source separation.

When the creator 20 requests audio source separation of the waveform 343, the information processing apparatus 100 executes audio source separation. Specifically, the information processing apparatus 100 inputs the waveform 343 to an audio source separation model that has been pre-trained to learn features of each audio source constituting the music, and generates the audio source separated from the waveform 343 in a format that can be handled on the DAW. The feature of each audio source constituting the music is, for example, a tone that characterizes each musical instrument such as a vocal, a guitar, and a bass. That is, the information processing apparatus 100 executes audio source separation using a model trained by machine learning to learn the features of the individual musical instruments and configured to output, in response to an input of a certain audio source, a new audio source having only the features of the individual musical instruments from the certain audio source.

When the audio source separation is performed on the waveform 343, a waveform 344, a waveform 345, and a waveform 346 are individually displayed side by side in the waveform 343 on the DAW. For example, the waveform 344 is an audio source obtained by extracting the bass sound from the audio source indicated by the waveform 343. Furthermore, the waveform 345 is an audio source obtained by extracting the guitar sound from the audio source indicated by the waveform 343. Furthermore, the waveform 346 is an audio source obtained by extracting the drum sound from the audio source indicated by the waveform 343. In this manner, the information processing apparatus 100 generates audio sources separated for individual musical instruments in a format that can be immediately handled on the DAW from the audio source desired by the creator 20. With this configuration, the creator 20 can quickly and accurately acquire a sound material desired to be used for own music production.

Furthermore, after executing the audio source separation, the information processing apparatus 100 searches the store audio source storage unit 65 for an audio source similar to the audio source that has undergone the separation. For example, the information processing apparatus 100 determines similarity between the separated audio source and an audio source (material) stored in the store audio source storage unit 65 using a known similarity analysis function of determining similarity for each music or audio source, and extracts an audio source having a relatively high similarity.

The information processing apparatus 100 displays the search result in a window 347. The window 347 illustrates an example of a result in a case where the creator 20 clicks a selection button 348 and requests search for a material by designating the drum as a musical instrument. That is, the audio source displayed in the search result illustrated in the window 347 is an audio source similar to the waveform 346 which is the separated drum audio source and is an audio source stored in the store audio source storage unit 65. The creator 20 may use the audio source of the waveform 346 in music production, or may perform viewing/listening of the searched similar audio source and acquire or purchase a favorite audio source to use.

The flow of the processing related to the audio source separation has been described above with reference to FIGS. 3 to 8. Note that the copyright holder of the separated audio source is not necessarily the creator 20. In addition, there is a possibility that the creator 20 performs music production using a similar audio source purchased from the store instead of the audio source obtained by audio source separation. Therefore, the information processing apparatus 100 provides, on the DAW, a copyright management function together with the audio source separation function.

### 1-3. Example of Assignment of Rights Information According to Embodiment

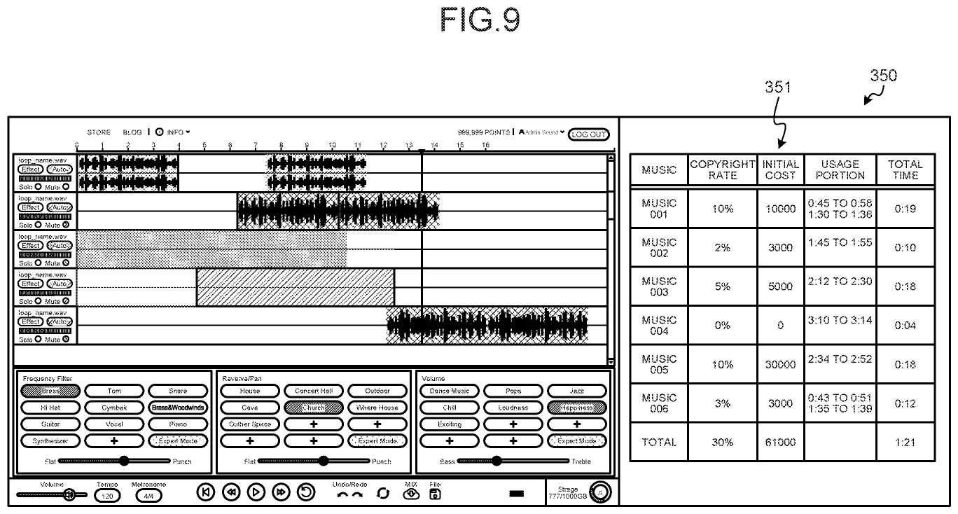

As described above, the DAW provided by the information processing apparatus 100 has a function of managing copyright information when the creator 20 creates music. In FIG. 9 and the following will describe the assignment of rights information, which is an example of the function of the DAW.

FIG. 9 is a user interface diagram (6) according to the embodiment. The example of FIG. 9 includes; a screen 350 on which the creator 20 is producing music on the DAW; and various pieces of information included in the screen 350.

As illustrated in FIG. 9, the left half of the screen 350 includes: individual tracks of the music to be produced by the creator 20; and audio sources included in the tracks displayed in the form of a waveform. These waveforms include a part of existing music, a material purchased from a store, and the like together with the audio source generated by recording or programming by the creator 20 themselves.

When the creator 20 adds an audio source to a track to be used for music production, the information processing apparatus 100 acquires rights information of the audio source. For example, the information processing apparatus 100 acquires, as the rights information, copyrights information assigned to the audio source. Furthermore, the information processing apparatus 100 acquires information related to use permission of the audio source, as the rights information. Specifically, the information processing apparatus 100 acquires information such as whether the audio source is permitted to be used for production of a different piece of music, a utilization time and a use portion permitted in a case where the audio source is used for production of the different piece of music, and a fee to be paid to the original copyright holder in a case where the audio source is used.

The information processing apparatus 100 displays the acquired rights information in a window 351. As illustrated in FIG. 9, the window 351 includes information such as the name of the music used as the audio source, the copyright rate of the music (for example, the rate set by the right holder for each use mode), the initial cost (the amount paid to the original copyright holder when the existing music is used), the usage portion (the portion where the existing music is used in the music), and the total time (the total time of use of the existing music in the music).

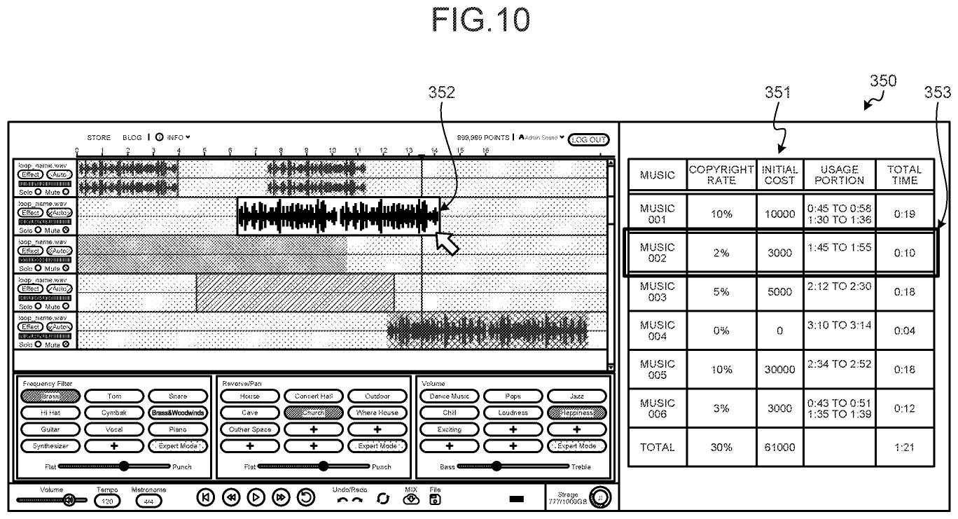

The creator 20 can select which audio source is to be actually used for the music with reference to the information displayed in the window 351. In addition, the creator 20 can check, at a glance, what kind of rights information is set to which audio source. This point will be described with reference to FIG. 10. FIG. 10 is a user interface diagram (7) according to the embodiment.

The example illustrated in FIG. 10 indicates a state in which the creator 20 selects a waveform 352 on the screen 350. At this time, the information processing apparatus 100 may highlight the waveform 352 such that the waveform 352 stands out from other waveforms. In addition, the information processing apparatus 100 may highlight a rights information 353 corresponding to the waveform 352 in the window 351 so as to stand out. With this configuration, the creator 20 can confirm information such as the cost when the waveform 352 is used in the music, and the total time of the waveform 352 to be used in the music. In a case, for example, where the creator 20 performs an operation to use the waveform 352 for more time in the subsequent processing, the information processing apparatus 100 may calculate the usage fee in real time and update the information displayed in the rights information 353.

In this manner, when performing music production including the audio source and the like downloaded by the creator 20, the information processing apparatus 100 executes the management function regarding the rights information of the audio source in the background without impairing the operability as a normal DAW. For example, such a management function manages music production while updating a range and portions used for music, a total utilization time, and the like, in addition to original audio source information itself used for sampling music. This makes it possible for the creator 20 to manage the sampling audio source when using another person's audio source without paying no particular attention of or taking notes of time lengths and modes in which the another person's audio source has been used.

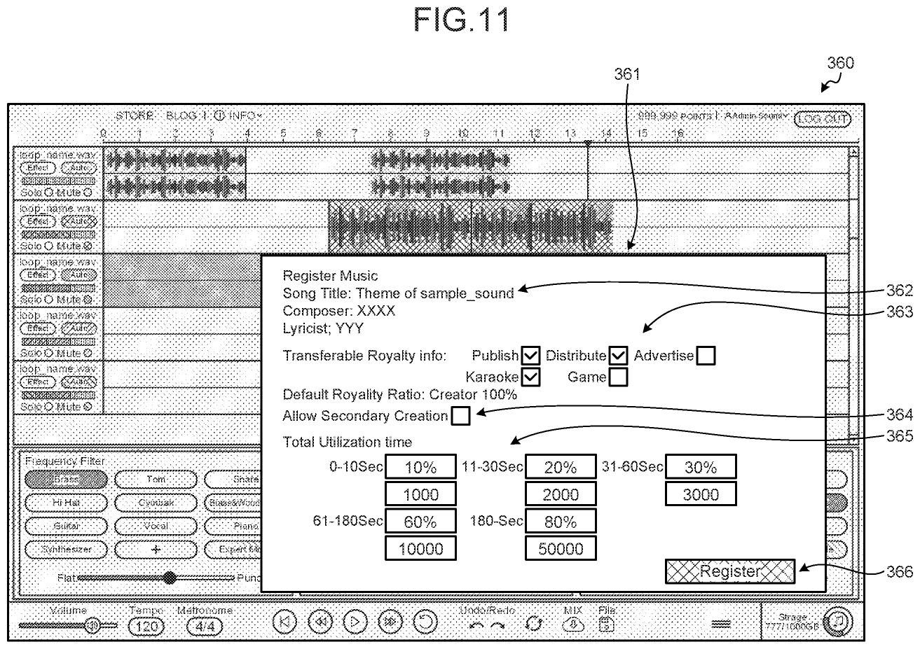

Next, processes of registering the rights information in the music after completion of music production by the creator 20 will be described. FIG. 11 is a user interface diagram (8) according to the embodiment. The example of FIG. 11 includes: a screen 360 on which the creator 20 is registering the rights information to the music on the DAW; and various pieces of information included in the screen 360.

As illustrated in FIG. 11, when the creator 20 tries to register the rights information in the music, the information processing apparatus 100 displays a window 361. The window 361 is a display unit for setting rights information to be registered by the creator 20.

For example, the creator 20 inputs the name of the music to an item 362. In addition, the creator 20 can select whether the music is transferable or entrustable to a predetermined field of use by marking the check box indicated in an item 363. For example, in the example of FIG. 11, the creator 20 can select whether the music is transferable to a publisher, transferable to a distribution site or the like, transferable to an advertiser, transferable to the karaoke industry, or transferable to the gaming industry.

In addition, the creator 20 can select whether to permit the secondary use of the music after the music is released (for example, registered in the store) by marking the check box indicated in an item 364. The secondary use of the music means producing a new piece of music by a third party using a part of the existing music.

The creator 20 can also set more detailed information regarding the secondary use. For example, the creator 20 can flexibly set the utilization time and the copyright rate displayed in an item 365. The example of FIG. 11 indicates the setting made by the creator 20 in which the copyright rate is 10% and the initial cost is 1000 yen when the utilization time in the secondary use is within 10 seconds.

When the setting of the rights information is completed, the creator 20 clicks a button 366. This makes it possible for the creator 20 to register the music together with the rights information. For example, the information processing apparatus 100 registers the music in a store linked with the DAW.

When a piece of music is newly registered, the information processing apparatus 100 may send a request, as a message, for a utilization contract to the copyright holder or the like of the original audio source. After confirming the mode of use, the copyright holder transmits permission of the utilization contract to the information processing apparatus 100. Note that such processing may be performed using a smart contract on a blockchain. In this case, the copyright holder or the like prescribes in the smart contract that “Use is permitted as long as use conditions are satisfied”, making it possible for the creator 20 to complete the use permission of the audio source and the new registration of the music by an automated contract with substantially no waiting time.

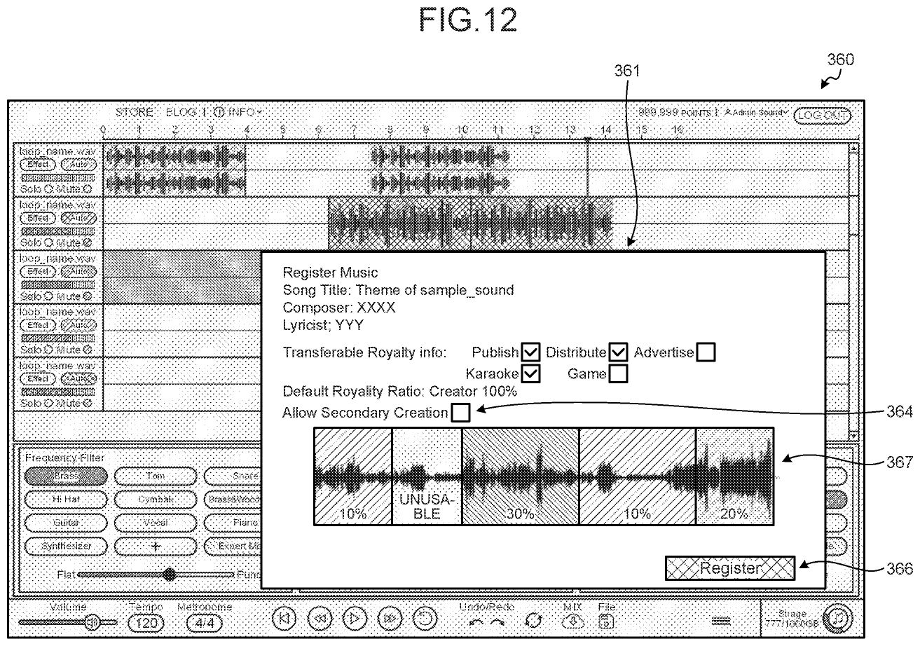

Next, a modification of the setting of the rights information will be described with reference to FIG. 12. FIG. 12 is a user interface diagram (9) according to the embodiment. FIG. 12 illustrates an example in which a music waveform 367 is displayed in the window 361 illustrated in FIG. 11.

The music waveform 367 indicates the entire music produced by the creator 20 in a waveform. For example, when allowing secondary use of a piece of music, the creator 20 can perform permission setting and a fee setting according to a portion of the music, such as permitting intro but not permitting the verse, and permitting the chorus. Specifically, the creator 20 refers to the music waveform 367 and sets a portion permitted by themselves for secondary use, a fee for the secondary use, and the like. In the example of FIG. 11, the creator 20 sets the copyright rate to 10% for the secondary use of the intro section, and sets non-permission for the secondary use of the verse. In addition, the creator 20 can flexibly set the permitted portion and fee, such as setting the copyright rate of the intro to a low rate of 10%, but setting the copyright rate of the chorus to a high rate of 30%. After completing the setting of the rights information, the creator 20 clicks the button 366 similarly to the example of FIG. 11.

In a case where the button 366 is clicked in the example of FIGS. 11 and 12, the information processing apparatus 100 registers the music, refers to the rights information included in the music, and executes various types of processing based on the referred information. For example, the information processing apparatus 100 transmits information indicating a mode in which the existing music is used to the original copyright holder of the existing music used by the created music. Furthermore, the information processing apparatus 100 assigns the rights information related to the created music based on the information set by the creator 20 or the copyrights information of the existing music. The information processing apparatus 100 writes the assigned rights information in a blockchain such as the information management system 50 illustrated in FIG. 1, making it possible for all related parties to refer to the rights information and possible to prevent falsification.

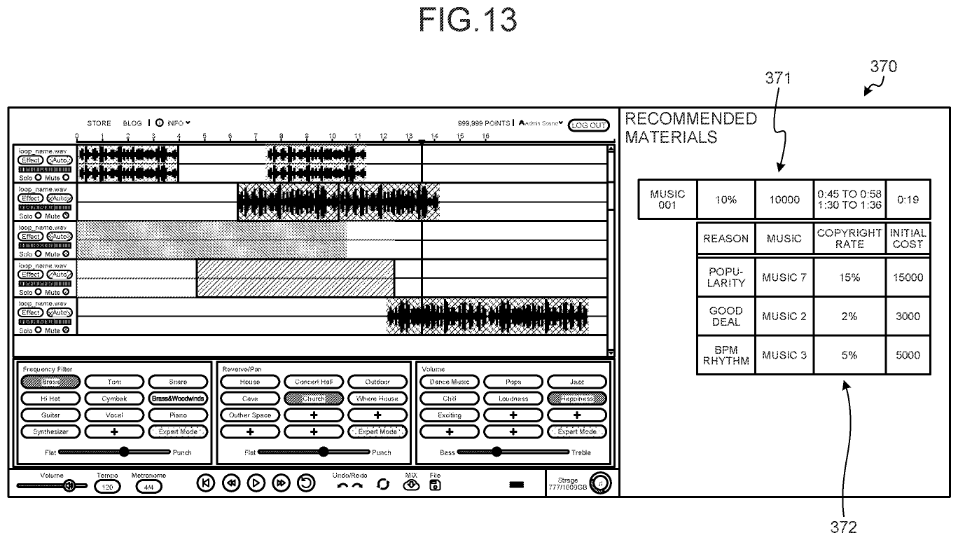

Next, a recommendation function in music production will be described with reference to FIG. 13. FIG. 13 is a user interface diagram (10) according to the embodiment. The example of FIG. 13 includes; a screen 370 on which the creator 20 is producing music on the DAW; and various pieces of information included in the screen 370.

As illustrated in FIG. 9 and the like, the creator 20 can confirm information of an audio source to use during music production in the DAW. Here, the information processing apparatus 100 may crawl the store audio source storage unit 65 or websites based on the audio source to be used by the creator 20, and may display the audio source to be recommended in a window 371.

For example, the information processing apparatus 100 searches for an audio source similar to music 001 that the creator 20 intends to use. Subsequently, the information processing apparatus 100 extracts an audio source to be recommended to the creator 20 from the searched audio source based on a predetermined determination criterion. For example, the information processing apparatus 100 presents a similar audio source with a lower utilization fee to the creator 20. Alternatively, the information processing apparatus 100 presents, to the creator 20, a popular audio source that is heavily used by other users among similar audio sources. Alternatively, the information processing apparatus 100 presents, to the creator 20, an audio source having a type of beat most similar to that of music 001 (for example, having close similarity in BPM or drum rhythm) among similar audio sources. As illustrated in a list 372, the information processing apparatus 100 displays, as the information related to the recommended audio source, reasons for recommendation, name of music (audio source), copyright rate or initial cost in use of the audio source, and the like. This makes it possible for the creator 20 to actively use unknown audio sources, leading to expansion of music production. In addition, the creator 20 can perform music production with suppressed cost of the copyright usage fee by selecting an audio source for which the usage fee is set to be low.

The flow of the processing related to the rights information assignment has been described above with reference to FIGS. 9 to 13. With functions such as audio source separation and rights information assignment implemented on the DAW, the information processing apparatus 100 can simplify complicated procedures conventionally performed by the creator 20, such as collection of sound materials and rights handling.

### 1-4. Configuration of Information Processing Apparatus According to Embodiment

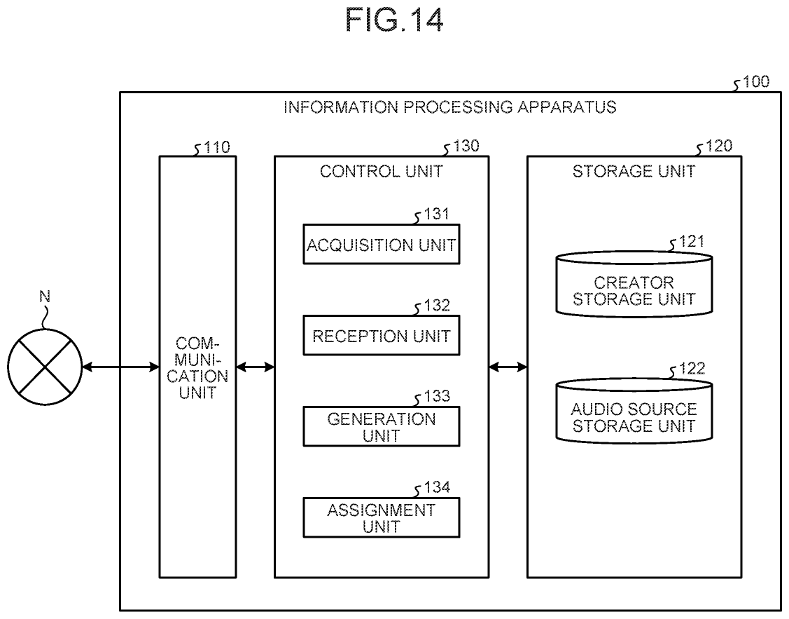

Next, a configuration of the information processing apparatus 100 according to the embodiment will be described. FIG. 14 is a diagram illustrating a configuration example of the information processing apparatus 100 according to the embodiment of the present disclosure.

As illustrated in FIG. 14, the information processing apparatus 100 includes a communication unit 110, a storage unit 120, and a control unit 130. The information processing apparatus 100 may include an input unit (for example, a keyboard, a mouse, etc.) that receives various operations from an administrator or the like of the information processing apparatus 100, and a display unit (for example, a liquid crystal display, etc.) for displaying various types of information.

The communication unit 110 is implemented by a device such as a network interface controller and a network interface card (NIC), for example. The communication unit 110 is connected to a network N (the Internet or the like) via a wired or wireless channel, and transmits and receives information to and from an external device such as the creator terminal 10 or in a blockchain such as the information management system 50 through the network N.

The storage unit 120 is implemented by semiconductor memory elements such as random access memory (RAM) and flash memory, or other storage devices such as a hard disk or an optical disc. The storage unit 120 includes a creator storage unit 121 and an audio source storage unit 122. Hereinafter, each storage unit will be described in order.

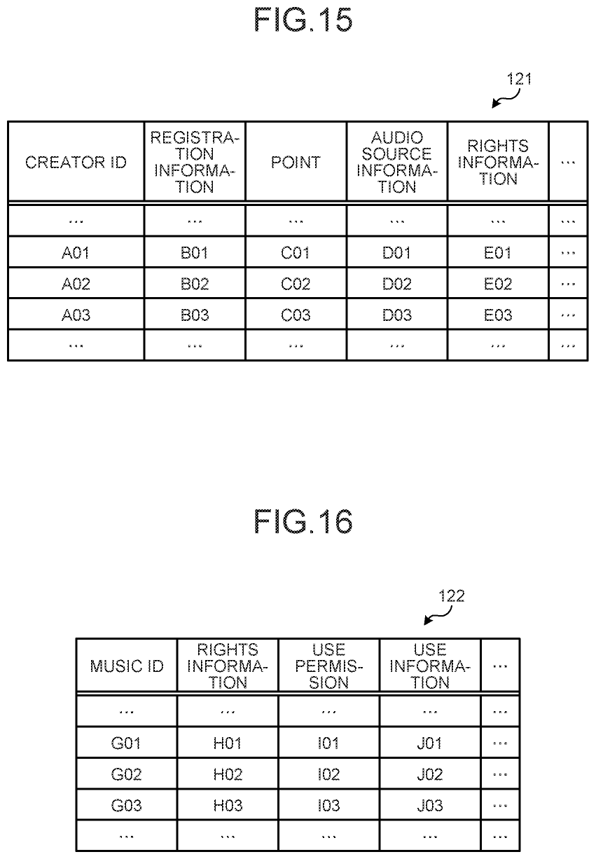

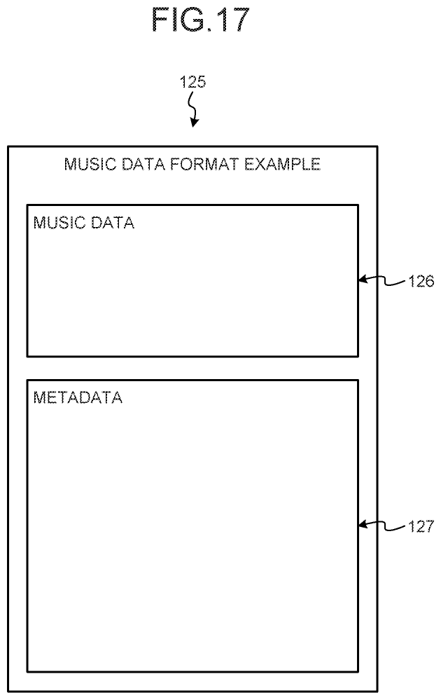

FIG. 15 is a diagram illustrating an example of the creator storage unit 121 according to the embodiment. As illustrated in FIG. 15, the creator storage unit 121 includes items such as “creator ID”, “registration information”, “point”, “audio source information”, and “rights information”. In FIGS. 15 and 16, the information stored in the storage unit 120 is conceptually illustrated as “A01”. In practice, however, each piece of information described below is stored in the storage unit 120. The creator storage unit 121 corresponds to the creator audio source storage unit 60 illustrated in FIG. 3, for example.

“Creator ID” is identification information for identifying the creator. The “registration information” includes an account name of the creator and information used at utilization of the DAW.

The “point” is information related to points required when the creator uses a service (for example, audio source separation in DAW) provided by the information processing apparatus 100. Although the embodiment uses an example in which the creator consumes points as a consideration paid for the service, the consideration may be currency, a token issued on a blockchain, or the like.

The “audio source information” is information related to an audio source owned by the creator. For example, the audio source information includes an audio source recorded by the creator on the DAW, existing music and sound materials purchased by the creator at a site or the like, and music produced by the creator on the DAW.

The “rights information” is information related to the right registered by the creator. For example, the rights information is registered for each piece of music, and includes various types of information such as the name of the music, copyright holder regarding the music, use permission when using the music, and use conditions (utilization fee according to a utilization time and a use location).

Next, the audio source storage unit 122 will be described. FIG. 16 is a diagram illustrating an example of the audio source storage unit 122 according to the embodiment. As illustrated in FIG. 16, the audio source storage unit 122 includes items such as “music ID”, “rights information”, “use permission”, and “use information”. The audio source storage unit 122 corresponds to the store audio source storage unit 65 illustrated in FIG. 3, for example.

The “music ID” is identification information identifying music held in the audio source storage unit 122. The music stored in the audio source storage unit 122 is, for example, music distributed or sold by a store linked with the DAW.

The “rights information” is information related to a right registered in the music. For example, the rights information is information registered for each piece of music and held as metadata different from music data (for example, music data such as a wav file). For example, the rights information includes information identifying the copyright holder regarding the music, the distribution agent of the music, the music publisher that manages the rights of the music, and the like.

The “use permission” is information related to permission at the time of secondary use of the music. For example, the use permission is registered for each piece of music, and includes various types of information such as use permission when using the music, and use conditions (utilization fee according to a utilization time and a used portion).

The “use information” is history information regarding the use of the music in the past. For example, the use information includes: the number of times and time duration of the viewing/listening of the music performed the user, the number of times of downloading of the music, the number of times of secondary use of the music, in which a part of the music is used for new music, the time duration taken from the music and included in the new music, the number of times and time duration regarding the viewing/listening of the new music, and the number of times of downloading of the new music. In addition, the use information may include information such as a copyright usage fee paid when the music is used as secondary use.

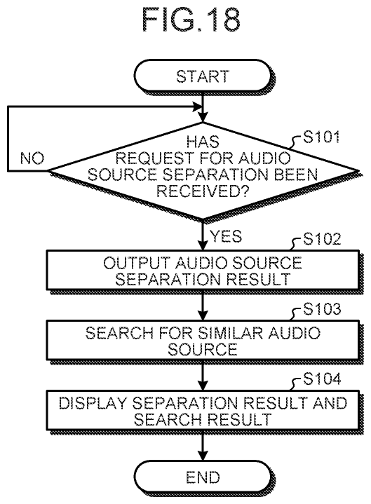

Here, information included in music data according to the embodiment will be described with reference to FIG. 17. FIG. 17 is a diagram illustrating a concept of music data according to the embodiment.

As illustrated in FIG. 17, music data 125 which is an example of the music data format according to the embodiment includes music data 126 and metadata 127. The music data 126 is digital data (binary data) such as a wav file, obtained by sampling music. The metadata 127 includes various types of information related to the music. For example, the metadata 127 includes rights information, permission information, use information, and the like illustrated in FIGS. 15 and 16. That is, the metadata 127 includes information such as the name of music, author information, and new music produced by secondary use. Information identifying each new piece of music or the like produced by secondary use is registered as metadata for the music. With this configuration, at the time of reference to certain music data, the information processing apparatus 100 can specify a new piece of music produced by the secondary use of the referenced music and specify information such as the duration and location of use of the original music by the newly produced music. The music data 125 illustrated in FIG. 17 is stored in the creator storage unit 121, the audio source storage unit 122, and the like.

Regarding the information illustrated in FIGS. 15 and 16, the information processing apparatus 100 stores information related to each creator and information related to the audio source. Furthermore, the information processing apparatus 100 registers the information illustrated in FIGS. 15 and 16 in the information management system 50 (blockchain). That is, the information illustrated in FIGS. 15 and 16 can be referenced and updated not only by the information processing apparatus 100 but also by the distribution agent 30, the music publisher 35, the copyright administrator 40, and the like by using the distributed ledger system based on the blockchain.

Returning to FIG. 14, and description will continue. The control unit 130 is implemented by execution of a program (for example, an information processing program according to the present disclosure) stored in the information processing apparatus 100 by a Central Processing Unit (CPU), a Micro Processing Unit (MPU), a Graphics Processing Unit (GPU), or the like, by using Random Access Memory (RAM) or the like, as a work area. In addition, the control unit 130 is a controller and may be implemented by an integrated circuit such as an application specific integrated circuit (ASIC) or a field programmable gate array (FPGA).

As illustrated in FIG. 14, the control unit 130 includes an acquisition unit 131, a reception unit 132, a generation unit 133, and an assignment unit 134, and implements or executes functions and operations of information processing described below. The internal configuration of the control unit 130 is not limited to the configuration illustrated in FIG. 14, and may be any other configuration as long as it is a configuration that performs information processing described below.

The acquisition unit 131 acquires various types of information. For example, the acquisition unit 131 acquires the audio source uploaded by the creator 20 via the DAW which is a cloud application provided to the creator terminal 10. In the following description, an audio source or existing music that can be a material of music production will be referred to as “first content” for distinction in some cases. Furthermore, new music produced by the creator 20 will be referred to as “second content” in some cases. That is, the acquisition unit 131 acquires the first content from the creator terminal 10. The acquisition unit 131 may acquire the first content via a store or the like.

In addition, the acquisition unit 131 acquires the rights information pre-assigned to the first content. The rights information pre-assigned to the first content is various types of information registered when the first content is generated, and an example of this is the rights information illustrated in FIG. 15.

Specifically, the acquisition unit 131 acquires, as the rights information, information related to permission and use conditions regarding secondary use which has been set in the first content. The acquisition unit 131 may acquire, as the rights information, information related to a plurality of right holders permitting the secondary use of the first content. For example, the acquisition unit 131 acquires information of a right holder having a copyright related to the first content. In addition, in a case where secondary use of the first content is performed, the acquisition unit 131 acquires names of a plurality of copyright holders whose permission is to be obtained, contact information of the copyright holders, contact information of groups that manage the copyright, and the like.

In addition, the acquisition unit 131 may acquire, as the rights information, information related to a permission and a use condition regarding distribution of the content produced by the secondary use of the first content. Specifically, in a case where new music is produced by the secondary use of the first content, the acquisition unit 131 acquires whether distribution of the new music is permitted, and a copyright usage fee, a copyright rate, and the like to be applied in the case of performing distribution. In addition, the acquisition unit 131 acquires a use condition such as whether distribution is to be permitted according to a utilization time or a utilization rate (a ratio of the first content to the second content) of the first content. For example, the acquisition unit 131 acquires the use condition registered in the first content, such as permitting distribution on the condition that the utilization time of the first content is within one minute or the utilization rate of the first content is 20% or less of the playback time of the second content.

Furthermore, the acquisition unit 131 may acquire, during music production or the like on the DAW, an audio source or the like other than the first content uploaded by the creator 20. For example, the acquisition unit 131 acquires a similar audio source that is an audio source similar to the first content from the audio source storage unit 122 or individual sites on the network N.

A reception unit 132 receives a request for separating the first content acquired by the acquisition unit 131 into a plurality of audio sources from a user (the creator 20 in the embodiment) who uses the DAW.

The reception unit 132 may calculate a consideration to be paid by the creator 20 in order to execute processing of separating the first content into a plurality of audio sources, present the calculated consideration to the creator 20, and then receive a request for separating the first content into a plurality of audio sources from the creator 20. For example, the reception unit 132 presents points required for separation as illustrated in FIG. 7 to the creator 20.

For example, the reception unit 132 may calculate the compensation based on data such as the playback time of the first content to undergo audio source separation, the number of audio sources to be newly generated by the separation, the popularity (use history from other creators, and the number of time of viewing/listening of the first content, and the like) of the first content.

Note that the reception unit 132 may receive a request for separating a part, instead of entire parts, of the first content from the creator 20. With this configuration, the generation unit 133 described below can execute processing more quickly than audio source separation of the entire parts of the first content.

Based on the request received by the reception unit 132, the generation unit 133 generates the audio source separated from the first content in a format that can be handled on the DAW by inputting the first content to a model pretrained to learn the features of individual audio sources constituting the music. The generation unit 133 corresponds to the audio source separation system 70 and the similar audio source search system 75 illustrated in FIG. 3.

For example, by inputting the first content to a model pretrained to learn features of each musical instrument constituting the music, the generation unit 133 generates an audio source of each musical instrument separated from the first content in a format that can be handled on the DAW.

Furthermore, after generating the audio source separated from the first content, the generation unit 133 may present a similar audio source, which is an audio source similar to the separated audio source, to the creator 20.

For example, as similar audio sources, the generation unit 133 presents, to the creator 20, an audio source having a similarity in a musical instrument used for an audio source separated from the first content, or similarity in the tempo or rhythm of the audio source separated from the first content.

Specifically, among the plurality of similar audio sources, the generation unit 133 presents, to the creator 20, audio sources in order from an audio source corresponding to at least one of the following elements: an audio source with a playback time having a higher similarity to the playback time of the audio source separated from the first content; an audio source with a pitch having a higher similarity to the audio source separated from the first content; or an audio source with a tone having a higher similarity to the audio source separated from the first content. The creator 20 can find a favorite similar audio source from similar audio sources listed in the window 347 illustrated in FIG. 8.

In addition, among a plurality of similar audio sources, the generation unit 133 may present, to the creator 20, similar audio sources in order from an audio source corresponding to at least one of the following elements: an audio source used more heavily by other users; an audio source used by another user to produce a piece of second content with a higher viewing/listening rate. This makes it possible for the creator 20 to preferentially find a material popular to other creators or an audio source preferred by the user who performs viewing/listening of the material.

In addition, when the creator 20 uses an audio source separated from the first content or a similar audio source, the generation unit 133 may present, to the creator 20, a similar audio source having a use condition with lower burden set on the creator 20. As described above, in a case where the creator 20 creates music using the first content or the separated audio source, there occurs a consideration to be paid such as a copyright usage fee in use of the audio source. Therefore, among similar audio sources, the generation unit 133 may preferentially present, to the creator 20, a similar audio source having a lower consideration to be paid set to the audio source, or a similar audio source with less strict use conditions (such as no restriction on the playback time, and no restriction on the portion of the audio source to use). This makes it possible for the creator 20 to perform music production using their favorite audio sources while suppressing the utilization fee to pay.

When generating the separated audio source, the generation unit 133 generates rights information of the audio source separated from the first content based on the rights information pre-assigned to the first content. For example, in a case where the use condition and the permission information for secondary use are included in the first content, the generation unit 133 pass on the included information to the rights information of the audio source separated from the first content. With this configuration, even when a new music is produced using a part of the first content as a material, the right holder of the first content can receive the share of the utilization fee corresponding to the use of the new music, and can track how the own audio source has been used for other new music pieces.

When the second content is produced by partially using the first content, the assignment unit 134 assigns rights information related to the second content based on the rights information acquired by the acquisition unit 131.

For example, the assignment unit 134 assigns, as the rights information of the second content, information indicating that production of the second content using the first content has been permitted. This makes it possible for the creator 20 to prove that the produced second content has been produced using the first content the secondary use of which is permitted.

In addition, when the second content is produced, the assignment unit 134 may assign information indicating that an agreement has been obtained from a plurality of right holders permitting the secondary use of the first content. When the secondary use is performed on the first content having a plurality of copyright holders, there may be a case where permission of a predetermined number of copyright holders (for example, all copyright holders) is required. In this case, when information indicating that an agreement has been obtained from the plurality of right holders is set as the rights information of the first content, the assignment unit 134 assigns this information as the rights information of the second content. This makes it possible for the creator 20 to prove that the second content is produced by using the first content having received a permission to use based on the agreement.

Furthermore, in a case where information related to a permission and a use condition regarding the distribution of the content produced by the secondary use is assigned to the first content, the assignment unit 134 may assign information indicating that the distribution of the second content is permitted, as the rights information related to the second content. With this configuration, in a case where the creator 20 desires to distribute the second content, the creator can distribute the second content without taking the trouble to obtain permission for distribution from the right holder of the first content. In a case where the second content is distributed based on the information set in the first content, the assignment unit 134 may also assign, to the second content, information such as a utilization fee to be shared to the right holder of the first content used as the material.

Furthermore, the assignment unit 134 assigns, as the rights information related to the second content, information of the right holder having the copyright related to the first content together with the right holder having the copyright related to the second content. In this case, as illustrated in FIG. 11 and the like, the creator 20 who has produced the second content registers the copyright information related to the second content.

Furthermore, based on the rights information assigned by the assignment unit 134, the acquisition unit 131 may search for other existing music pieces or an audio source serving as a material to be recommended to the creator 20.

For example, the acquisition unit 131 may refer to the rights information pre-assigned to the first content, and acquire a different piece of first content to which an advantageous use condition is assigned compared with the use condition indicated in the rights information.

Specifically, the acquisition unit 131 refers to information related to the utilization fee in a case where the second content is produced by partially using the first content as the rights information pre-assigned to the first content, and acquires a different piece of first content to which a utilization fee lower than the utilization fee is assigned. With this configuration, the creator 20 can find existing music and audio sources that can be used at a lower price.

In addition, the acquisition unit 131 may refer to history information indicating the use of the first content at past production of music, and may acquire a different piece of first content to which history information indicating higher use history is assigned. That is, the acquisition unit 131 may acquire highly popular first content used by more creators and present the acquired first content to the creator 20 as recommended content.

When the rights information pre-assigned to the first content is acquired during the production of the second content, the acquisition unit 131 may display a list of the rights information pre-assigned to the first content on a user interface that controls the production of the second content. For example, the acquisition unit 131 displays the window 351 illustrated in FIG. 9 on the DAW, and displays the acquired rights information so as to be viewable by the creator 20.

Specifically, when the second content is produced by partially using the first content, the acquisition unit 131 displays, on the user interface, a utilization fee to be paid by the producer of the second content to the right holder of the first content. This makes it possible for the creator 20 to confirm at a glance the type of the first content included as a material in the second content to be produced by the creator and the amount of utilization fee to be paid.

Alternatively, the acquisition unit 131 may display, as the utilization fee, a utilization fee individually set for the time length of use of the first content in the second content or individually set for each configuration of the first content. For example, the acquisition unit 131 acquires the copyright rate and the initial cost set for each piece of the first content as in a window 351 illustrated in FIG. 9, and displays the acquired information. This makes it possible for the creator 20 to proceed with production while confirming the utilization fee to be paid for a certain piece of first content when used for a certain period of time.

Meanwhile, the assignment unit 134 may assign, as the rights information related to the second content, information indicating whether to permit the secondary use, which is in the form of partially using the second content to produce third content being a new piece of content. As described above, the permission information related to the second content is set by the creator 20 and registered on the DAW. The information is assigned to the second content by the assignment unit 134 and registered in the information management system 50 (blockchain). At this time, the creator 20 can set a permission condition at the time of secondary use of the second content held by the creator 20 as its right holder. With this setting, when the second content created by the creator 20 is used by a third party, the creator 20 can obtain shared profit based on the use.

As illustrated in FIG. 11 and the like, the assignment unit 134 assigns use conditions including a time length of use of the second content in the third content or a utilization fee individually set for each configuration of the second content.

In addition, in response to a request from the author of the second content (creator 20 or a person to whom copyright is entrusted by the creator 20), the assignment unit 134 may distribute the second content to which the information indicating whether the secondary use of the second content is permitted and the use conditions are assigned. Specifically, the assignment unit 134 can distribute the second content by entrusting the distribution of the second content to the distribution agent 30. For example, by registering, on the information management system 50, the message that the author desires to distribute the second content, the assignment unit 134 can start distribution by the distribution agent 30 that has received such information.

In this manner, the assignment unit 134 registers rights information related to the second content to ledger data of the blockchain, which is constructed with at least one of the distributor of the second content (the distribution agent 30), the administrator of the rights information assigned to the second content (the music publisher 35), or the collector who collects the utilization fee when the second content is used (the copyright administrator 40). Since the blockchain has a structure that does not easily permit falsification of data, the assignment unit 134 can safely hold the rights information related to the second content and the like.

### 1-5. Information Processing Procedure According to Embodiment

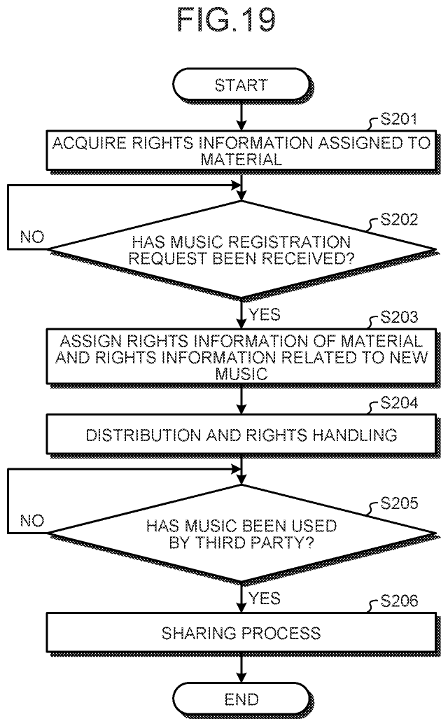

Next, an information processing procedure according to the embodiment will be described with reference to FIGS. 18 to 20. First, a flow of information audio source separation processing according to the embodiment of the present disclosure will be described with reference to FIG. 18. FIG. 18 is an information processing procedure flowchart (1) according to the embodiment.

As illustrated in FIG. 18, the information processing apparatus 100 determines whether a request for audio source separation has been received from the creator 20 (Step S101). When the request has not been received (Step S101; No), the information processing apparatus 100 waits until the request is received.

In contrast, in a case where the request has been received (Step S101; Yes), the information processing apparatus 100 outputs a result of the audio source separation (Step S102).

Subsequently, the information processing apparatus 100 searches for a similar audio source, which is similar to the separated audio source (Step S103). The information processing apparatus 100 then displays the separation result and the search result on the user interface of the DAW (Step S104).

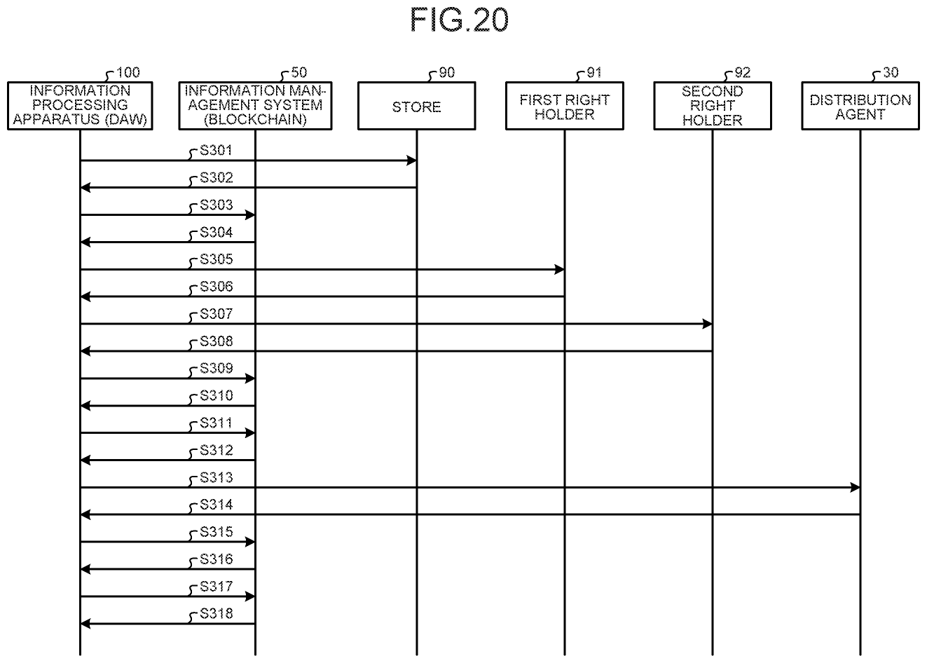

Next, a flow of rights information assignment according to the embodiment of the present disclosure will be described with reference to FIG. 19. FIG. 19 is an information processing procedure flowchart (2) according to the embodiment.

As illustrated in FIG. 19, the information processing apparatus 100 acquires rights information assigned to a material of new music (Step S201). Thereafter, the information processing apparatus 100 determines whether a request for music registration has been received from the creator 20 who has produced the new music (Step S202). When the request has not been received (Step S202; No), the information processing apparatus 100 waits until the request is received.

In contrast, in a case where the request has been received (Step S202; Yes), the information processing apparatus 100 assigns rights information related to the material and rights information related to the music set by the creator 20 to the music (Step S203). In a case where music has been produced based on a plurality of materials, the information processing apparatus 100 may assign the rights information of all the materials to the new music.

Thereafter, the information processing apparatus 100 executes new music distribution and rights handling (Step S204). For example, the information processing apparatus 100 executes processing such as transmitting an audio source to the distribution agent 30 and transferring a copyright to the music publisher 35.

Thereafter, the information processing apparatus 100 determines whether the music has been used by a third party (Step S205). When the information has not been used by a third party (Step S205; No), the information processing apparatus 100 waits until the music is used by a third party.

In contrast, in a case where the music has been used by a third party (Step S205; Yes), the information processing apparatus 100 executes a sharing process of the copyright usage fee and the like based on the usage and the rights information set in the music (Step S206).

Next, a flow of rights handling performed by the information processing system 1 according to the embodiment will be described with reference to FIG. 20. FIG. 20 is a sequence diagram illustrating a procedure of the information processing system 1 according to the embodiment. FIG. 20 illustrates an example in which two right holders (a first right holder 91 and a second right holder 92) are present for an audio source as a material of a new music when the new music is produced.

In the example illustrated in FIG. 20, the information processing apparatus 100 (that is, the DAW) searches a store 90 for a material desired by the creator 20 in accordance with the operation by the creator 20 (Step S301). The store 90 transmits a search result to the information processing apparatus 100 (Step S302). The information processing apparatus 100 displays the search result on the DAW, and acquires the audio source from the store 90 in response to the purchase request of the creator 20.

Subsequently, the information processing apparatus 100 accesses the information management system 50 and refers to the metadata of the audio source acquired (Step S303). For example, the information processing apparatus 100 inquires about information such as whether the secondary use of the audio source is permitted and what the use conditions are. Furthermore, the information processing apparatus 100 refers to the metadata and acquires information related to the right holder such as the copyright holder registered in the audio source (Step S304).

In a case where the music has been produced using the audio source acquired in Step S302, the information processing apparatus 100 accesses the first right holder 91 who is a right holder of the audio source, and transmits the information related to a music utilization contract (Step S305). Such processing is executed by the DAW, for example, in response to the click operation on the button 366 illustrated in FIG. 11 by the creator 20.

For example, the information processing apparatus 100 transmits, to the first right holder 91, information such as the fact of use of an audio source for new music, the utilization time, a use mode, used portions, and the like. In a case where the first right holder 91 determines that the use satisfies the use condition, the first right holder transmits the music use agreement to the information processing apparatus 100 (Step S306). The first right holder 91 may perform presetting so as to automatically return information related to the agreement rather than intentionally transmitting the information related to the agreement in a case where the information processing apparatus 100 determines that the use has satisfied the use condition.

Similarly to Step S305, the information processing apparatus 100 transmits the information related to the music utilization contract to the second right holder 92 (Step S307). The second right holder 92 refers to the music utilization contract and transmits the agreement on the use of the music to the information processing apparatus 100 (Step S308). When there are more right holders related to the audio source, the information processing apparatus 100 repeats the processing of Steps S307 and S308 by the number of right holders.

When agreement is obtained from all the right holders, the information processing apparatus 100 registers the fact of agreement on the contract in the information management system 50 (Step S309). In a case where the information is approved on the blockchain, the information management system 50 transmits the fact of approval to the information processing apparatus 100 (Step S310). Such information is written into the metadata of the audio source acquired in Step S302 and the metadata of the new music to be registered subsequently, for example.

Subsequently, the information processing apparatus 100 registers newly produced music to which information such as the right holder and the use condition have been assigned, in the information management system 50 (Step S311). In a case where the information is approved on the blockchain, the information management system 50 transmits the fact of approval to the information processing apparatus 100 (Step S312).

Thereafter, the information processing apparatus 100 entrusts the distribution agent 30 to distribute the music in response to the request of the creator 20 (Step S313). Note that the information processing apparatus 100 may perform processing such as transferring the right to the music publisher 35 in parallel with Step S313. The distribution agent 30 transmits the fact that the distribution contract is agreed upon to the information processing apparatus 100 (Step S314).

Thereafter, the information processing apparatus 100 registers, in the information management system 50, information related to the distribution contract agreement including the rights information of the distribution agent 30 or the like that has obtained the right to distribute the music (Step S315). In a case where the information is approved on the blockchain, the information management system 50 transmits the fact of approval to the information processing apparatus 100 (Step S316).

Thereafter, when there is an inquiry about the music (for example, an inquiry about a usage status, a distribution status, and a reward status) from the creator 20 or the like, the information processing apparatus 100 refers to the information management system 50 for the music information corresponding to the inquiry (Step S317). When having acquired the information corresponding to the inquiry from the information management system 50, the information processing apparatus 100 displays the acquired information on the DAW (Step S318).

As described above, according to the information processing system 1, the creator 20 can view the information of his/her own music on the DAW at any time even after the music distribution contract or the like has been made. With this configuration, the creator 20 can confirm integrated information regarding the rights information and the reward information which are likely to be distributed in music distribution on the DAW, and can easily update the contract and management information.

### 1-6. Modification of Embodiment

### 1-6-1. Operation as Information Processing System

The above embodiment is an example in which the information processing according to the present disclosure is executed by the information processing apparatus 100. Alternatively, the information processing according to the present disclosure may be executed in cooperation with the creator terminal 10 which is a local terminal, the distribution agent 30, and the like. That is, the information processing according to the present disclosure may be executed on the information processing system 1 including various devices, not limited to those exemplified in the embodiment.

### 1-6-2. Rights Information

The above embodiment is an example in which rights information, namely, information related to a copyright of music, permission of secondary use of music, use conditions, and the like, is recorded as metadata. However, the rights information is not limited thereto.

For example, the rights information may include not only information regarding a lyricist and a composer but also information regarding an arranger, a person to whom a copyright is transferred, a performer, or a person having author neighboring rights. In addition, the rights information may include setting of an interest and a reward amount of each right holder, consensus information (agreement information) indicating an agreement of each right holder regarding the interest, contract details and a message when the agreement is reached, a contact address of each right holder, and the like. Furthermore, the metadata of the music may include rights information related to all audio sources incorporated as materials in the music.

Furthermore, the rights information may include a digital signature or the like indicating that the creator 20, the distribution agent, or the like has agreed to the distribution contract or the transfer of the right. In addition, the rights information may include a distribution amount such as how much money is to be shared per a single distribution of music, a ratio of a reward amount shared to each right holder, the share of a copyright usage fee to be obtained by each copyright holder, and the like.

Furthermore, the above-described embodiment is an example in which the use permission of the audio source to be used for the new music is automatically executed using the smart contract. In this case, the information processing apparatus 100 may proceed with the automatic contract according to individual conditions set in each piece of rights information, such as “the use of the audio source is approved with the permission of some percentage of the entire copyright holders”, rather than receiving permissions from all the copyright holders. In this manner, the information processing apparatus 100 can improve the efficiency of music production and subsequent distribution processing by flexibly and quickly executing processes such as use permission.

### 1-6-3. Production System

The above-described embodiment is an example in which creation of music is executed on the creator terminal 10 operated by the creator 20. Alternatively, the music may be simultaneously produced in parallel by a plurality of terminal devices operated by a plurality of creators.

As described above, by providing the DAW as a cloud application, the information processing apparatus 100 can perform cloud sharing or files currently handled by a plurality of creators. With this configuration, the plurality of creators can produce music while operating one work file in parallel.

In addition, the information processing apparatus 100 performs real-time acquisition of the rights information of the material included in the currently handled file for production and displays the acquired rights information on the DAW. This enables the plurality of creators to proceed with the production while constantly confirming types of material included as the material being produced or estimated cost.

### 2. Other Embodiments

The process according to each of embodiments described above may be performed in various different forms (modifications) in addition to each of embodiments described above.

For example, among each process described in the individual embodiments described above, all or a part of the processes described as being performed automatically may be manually performed, or the processes described as being performed manually can be performed automatically by a known method. In addition, the processing procedures, specific names, and information including various data and parameters depicted in the above specifications or drawings can be changed in any manner unless otherwise specified. For example, a variety of information illustrated in each of the drawings are not limited to the information illustrated.

In addition, each of components of each device is provided as a functional and conceptional illustration and thus does not necessarily need to be physically configured as illustrated. That is, the specific form of distribution/integration of each device is not limited to those depicted in the drawings, and all or a part thereof may be functionally or physically distributed or integrated into arbitrary units according to various loads and use conditions.

Furthermore, the above-described embodiments and modifications can be appropriately combined within a range implementable without contradiction of processing.

The effects described in the present specification are merely examples, and thus, there may be other effects, not limited to the exemplified effects.

### 3. Effects of Information Processing Apparatus According to Present Disclosure

As described above, the information processing apparatus (the information processing apparatus 100 in the embodiment) according to the present disclosure includes the acquisition unit (the acquisition unit 131 in the embodiment), the reception unit (the reception unit 132 in the embodiment), the generation unit (the generation unit 133 in the embodiment), and the assignment unit (the assignment unit 134 in the embodiment).

The acquisition unit acquires the first content. The reception unit receives a request for separating the first content acquired by the acquisition unit into a plurality of audio sources from the user of the DAW (the creator 20 in the embodiment). Based on the request received by the reception unit, the generation unit generates the audio source separated from the first content in a format that can be handled on the DAW by inputting the first content to a model pretrained to learn the features of each audio source constituting the music.

In this manner, the information processing apparatus can separate the audio source in a form according to the request of the creator even from the existing music, for example, and can generate an audio source in a form that can be handled on the DAW, making it possible to improve the efficiency of recent music production frequently using sampled materials and the like.

In addition, by inputting the first content to a model pretrained to learn features of each musical instrument constituting the music, the generation unit generates an audio source of each musical instrument separated from the first content in a format that can be handled on the DAW.

In this manner, since the information processing apparatus can separate the audio source for each musical instrument, it is possible to appropriately provide the audio source desired by the creator in music production.

Furthermore, after generating the audio source separated from the first content, the generation unit presents a similar audio source, which is an audio source similar to the separated audio source, to the user.

In this manner, by presenting not only the separated audio source but also the similar audio source, the information processing apparatus can provide an audio source similar to the audio source desired by the creator to the creator and support the music production.

Furthermore, as similar audio sources, the generation unit presents, to the user, an audio source having a similarity in a musical instrument used for an audio source separated from the first content, or similarity in the tempo or rhythm of the audio source separated from the first content.

In this manner, the information processing apparatus can efficiently search for the audio source desired by the creator by determining the similarity based on the musical instrument (that is, the tone), the tempo, and the like.

Furthermore, among the plurality of similar audio sources, the generation unit presents, to the user, audio sources in order from an audio source corresponding to at least one of the following elements: an audio source with a playback time having a higher similarity to the playback time of the audio source separated from the first content; an audio source with a pitch having a higher similarity to the audio source separated from the first content; or an audio source with a tone having a higher similarity to the audio source separated from the first content.

In this manner, the information processing apparatus presents the searched similar audio sources as a list in the creator, thereby increasing the choices of the creator and encouraging more active music production.

In addition, among a plurality of similar audio sources, the generation unit presents, to the user, similar audio sources in order from an audio source corresponding to at least one of the following elements: an audio source used more heavily by other users; or a similar audio source used by another user to produce a piece of second content with a higher viewing/listening rate.

In this manner, the information processing apparatus presents the similar audio source according to the popularity of the audio source, making it possible to provide the creator with information including type of audio source popular among many users.

In addition, the acquisition unit acquires a use condition pre-assigned to the first content. When the user uses an audio source separated from the first content or a similar audio source, the generation unit presents, to the user, a similar audio source having a use condition with lower burden set on the user.

In this manner, the information processing apparatus can preferentially provide an audio source with lower burden on the creator by presenting a similar audio source according to a condition (permission, copyright usage fee, or the like) when the creator uses the first content for the music, making it possible to encourage the creator to perform music production.

In addition, the reception unit calculates a consideration to be paid by the user in order to execute processing of separating the first content into a plurality of audio sources, presents the calculated consideration to the user, and then receives, from the user, a request for separating the first content into a plurality of audio sources.

In this manner, by accepting audio source separation after indicating a compensation such as points, the information processing apparatus can promote monetization in music production using the DAW.

In addition, the acquisition unit acquires rights information pre-assigned to the first content. The generation unit generates the rights information of the audio source separated from the first content based on the rights information pre-assigned to the first content.

In this manner, by taking over the rights information assigned to the first content even for the separated audio source, the information processing apparatus can prevent illegal use of the first content or failure to deliver fair reward to the right holder of the first content.

In addition, the reception unit receives a request for separating a part of the first content from the user. The generation unit inputting the part of the first content to the model, thereby generating an audio source separated from the part of the first content.

In this manner, by applying audio source separation on only a part of the audio sources, the information processing apparatus can quickly perform separation processing.

In addition, the acquisition unit acquires rights information pre-assigned to the first content. When the second content (in the embodiment, new music produced by the creator 20) is produced by partially using the first content, the assignment unit assigns rights information related to the second content based on the rights information acquired by the acquisition unit.

In this manner, based on the rights information of the first content, the information processing apparatus assigns appropriate rights information to the second content produced using a sampled material. With this configuration, the information processing apparatus can eliminate complicated rights handling occurring on the creator and can prevent occurrence of errors in rights setting due to manual input or the like, making it possible to efficiently perform music management.

In addition, the acquisition unit acquires information related to permission and a use condition regarding secondary use set in the first content, as the rights information pre-assigned to the first content. The assignment unit assigns, as the rights information related to the second content, information indicating that production of the second content using the first content has been permitted.

In this manner, by taking over the permission information of the secondary use of the first content to the second content, the information processing apparatus can easily set the rights information of the second content while sharing an appropriate reward to the right holder of the first content.

In addition, the acquisition unit acquires information related to a plurality of right holders permitting the secondary use of the first content, as the rights information pre-assigned to the first content. When the second content is produced, the assignment unit assigns information indicating that an agreement has been obtained from a plurality of right holders permitting the secondary use of the first content.

In this manner, by assigning the agreement information of the plurality of right holders as the rights information, the information processing apparatus can prove that the second content is the content produced through a proper procedure.

In addition, the acquisition unit acquires, as the rights information pre-assigned to the first content, information related to permission and a use condition regarding distribution of the content produced by secondary use of the first content. The assignment unit assigns information indicating that the distribution of the second content is permitted, as the rights information related to the second content.

In this manner, by taking over the information related to the distribution of the first content, the information processing apparatus can efficiently perform processing of sharing the profit at the distribution of the second content, to the right holder of the first content.

In addition, the acquisition unit acquires, as the rights information pre-assigned to the first content, information related to a right holder having a copyright related to the first content. The assignment unit assigns, as the rights information related to the second content, information of the right holder having the copyright related to the first content together with the right holder having the copyright related to the second content.

In this manner, by including the copyright holder information of the first content in the second content, the information processing apparatus can efficiently perform processing of notifying the right holder that the first content has been used for production of a different piece of music, the sharing process of the copyright usage fee, and the like.

In addition, the acquisition unit refers to the rights information pre-assigned to the first content, and acquires a different piece of first content to which an advantageous use condition is assigned compared with the use condition indicated in the rights information.

In this manner, since the information processing apparatus can recommend a material that can be used under more advantageous conditions to the creator who intends to use the first content, it is possible to activate music production by the creator.

Additionally, the acquisition unit refers to information related to the utilization fee in a case where the second content is produced by partially using the first content as the rights information pre-assigned to the first content, and acquires a different piece of first content to which a utilization fee lower than the utilization fee is assigned.

In this manner, by recommending a material to which a lower utilization fee is set, the information processing apparatus can activate music production by the creator.

In addition, the acquisition unit refers to history information indicating the use of the first content at past production of the second content, and acquires a different piece of first content to which history information indicating higher use history is assigned.

In this manner, by recommending a material according to a history of use of the material, in other words, based on popularity of the material, the information processing apparatus can promote music production estimated to be popular among a larger number of users.

Furthermore, when the rights information pre-assigned to the first content is acquired during the production of the second content, the acquisition unit displays a list of the rights information pre-assigned to the first content on a user interface that controls the production of the second content.

In this manner, by displaying the rights information on the window of the DAW, for example, the information processing apparatus can perform real-time provision, to the creator, of information such as what types of material are used in music production.

In addition, when the second content is produced by partially using the first content, the acquisition unit displays, on the user interface, a utilization fee to be paid by the producer of the second content to the right holder of the first content.

In this manner, by performing real-time display of the cost required when the music is produced, the information processing apparatus can let the creator have prior recognition of the utilization fee of the material, which is a concern for the creator.

Alternatively, the acquisition unit displays, as the utilization fee, a utilization fee individually set for the time length of use of the first content in the second content or individually set for each configuration of the first content.

In this manner, by displaying, on the DAW, how much the utilization fee would be needed by using a certain amount of material for a certain period of time, the information processing apparatus can make a real-time notification of the cost related to music production to the creator.

In addition, the assignment unit assigns, as the rights information related to the second content, information indicating whether to permit the secondary use, which is in the form of partially using the second content to produce third content being a new piece of content.

In this manner, by assigning rights information to the second content. the information processing apparatus can easily set the rights information, which conventionally takes time and effort on the creator.

In addition, the assignment unit assigns use conditions including a time length of use of the second content in the third content or a utilization fee individually set for each configuration of the second content.

In this manner, by assigning the condition regarding the use of the second content, the information processing apparatus can share an appropriate utilization fee to the right holder of the second content in a case where the second content is used. This makes it possible for the information processing apparatus give an incentive for the creator to perform music production.

Furthermore, the acquisition unit acquires a distribution request of the second content from the copyright holder of the second content. In response to the distribution request acquired by the acquisition unit, the assignment unit distributes the second content to which the information indicating whether the secondary use of the second content is permitted and the use condition have been assigned.

In this manner, by receiving the distribution request via the DAW or the like, the information processing apparatus can easily perform the distribution setting which conventionally requires time and effort on the creator.

Furthermore, the assignment unit registers rights information related to the second content to the ledger data of a blockchain, which is constructed with at least one of the distributor of the second content, the administrator of the rights information assigned to the second content, or the collector who collects the utilization fee when the second content is used.

In this manner, by registering the rights information using a blockchain, the information processing apparatus can prevent data falsification and improve convenience for various entities to access or update the rights information.

### 4. Hardware Configuration

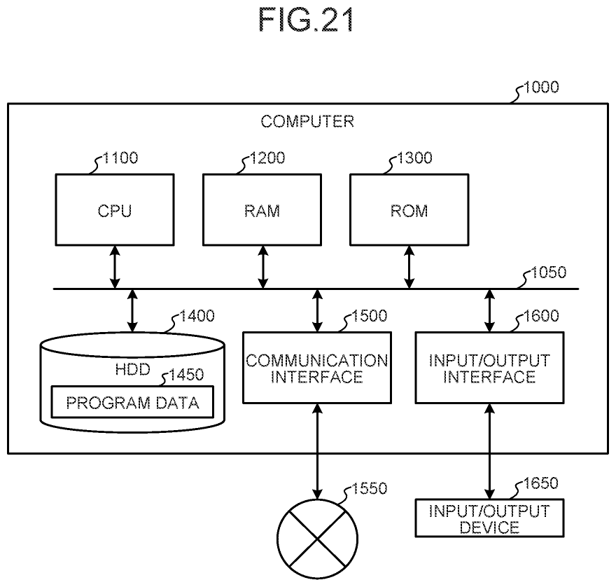

The information device such as the information processing apparatus 100 according to the above-described individual embodiments are implemented by a computer 1000 having a configuration as illustrated in FIG. 21, for example. Hereinafter, the information processing apparatus 100 according to the embodiment will be described as an example. FIG. 21 is a hardware configuration diagram depicting an example of the computer 1000 that implements functions of the information processing apparatus 100. The computer 1000 includes a CPU 1100, RAM 1200, read only memory (ROM) 1300, a hard disk drive (HDD) 1400, a communication interface 1500, and an input/output interface 1600. Individual components of the computer 1000 are interconnected by a bus 1050.

The CPU 1100 operates based on a program stored in the ROM 1300 or the HDD1400 so as to control each of components. For example, the CPU 1100 develops the program stored in the ROM 1300 or the HDD1400 into the RAM 1200 and executes processing corresponding to various programs.

The ROM 1300 stores a boot program such as a basic input output system (BIOS) executed by the CPU 1100 when the computer 1000 starts up, a program dependent on hardware of the computer 1000, or the like.

The HDD1400 is a non-transitory computer-readable recording medium that records a program executed by the CPU 1100, data used by the program, or the like. Specifically, the HDD1400 is a recording medium that records an information processing program according to the present disclosure, which is an example of program data 1450.

The communication interface 1500 is an interface for connecting the computer 1000 to an external network 1550 (for example, the Internet). For example, the CPU 1100 receives data from other devices or transmits data generated by the CPU 1100 to other devices via the communication interface 1500.

The input/output interface 1600 is an interface for connecting an input/output device 1650 with the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Furthermore, the input/output interface 1600 may function as a media interface for reading a program or the like recorded on predetermined recording medium (or simply medium). Examples of the media include optical recording media such as a digital versatile disc (DVD) or a phase change rewritable disk (PD), a magneto-optical recording medium such as a magneto-optical disk (MO), a tape medium, a magnetic recording medium, and semiconductor memory.

For example, when the computer 1000 functions as the information processing apparatus 100 according to the embodiment, the CPU 1100 of the computer 1000 executes the information processing program loaded on the RAM 1200 so as to implement the functions of the control unit 130 and the like. Furthermore, the HDD 1400 stores the information processing program according to the present disclosure or data in the storage unit 120. While the CPU 1100 executes program data 1450 read from the HDD1400, the CPU 1100 may acquire these programs from another device via the external network 1550, as another example.

Note that the present technique can also have the following configurations.
(1) An information processing apparatus comprising:
   an acquisition unit that acquires rights information pre-assigned to first content; and
   an assignment unit that performs, in a case where second content has been produced by partially using the first content, assignment of rights information related to the second content based on the rights information acquired by the acquisition unit.
(2) The information processing apparatus according to (1),
   wherein the acquisition unit acquires, as the rights information pre-assigned to the first content, information related to permission and use conditions regarding secondary use that has been set in the first content, and
   the assignment unit assigns, as the rights information related to the second content, information indicating that production of the second content using the first content is permitted.
(3) The information processing apparatus according to (2),
   wherein the acquisition unit acquires, as the rights information pre-assigned to the first content, information related to a plurality of right holders permitting secondary use of the first content, and
   the assignment unit assigns, when the second content is produced, information indicating that an agreement has been obtained from the plurality of right holders permitting secondary use of the first content.
(4) The information processing apparatus according to any one of (1) to (3),
   wherein the acquisition unit acquires, as the rights information pre-assigned to the first content, information related to permission and use conditions related to distribution of content produced by the secondary use of the first content, and
   the assignment unit assigns, as the rights information related to the second content, information indicating that distribution of the second content is permitted.
(5) The information processing apparatus according to any one of (1) to (4),
   wherein the acquisition unit acquires, as the rights information pre-assigned to the first content, information related to a right holder having a copyright related to the first content, and
   the assignment unit assigns, as the rights information related to the second content, information related to a right holder having a copyright related to the first content together with information relate to a right holder having a copyright related to the second content.
(6) The information processing apparatus according to any one of (1) to (5),
   wherein the acquisition unit refers to the rights information pre-assigned to the first content, and acquires a different piece of first content to which an advantageous use condition is assigned compared with the use condition indicated in the rights information.
(7) The information processing apparatus according to (6),
   wherein the acquisition unit refers to information related to a utilization fee in a case where the second content is produced by partially using the first content, as the rights information pre-assigned to the first content, and acquires the different piece of first content to which a utilization fee lower than the utilization fee is assigned.
(8) The information processing apparatus according to any one of (1) to (7),
   wherein the acquisition unit refers to history information indicating the use of the first content at past production of the second content, and acquires a different piece of first content to which history information indicating higher use history is assigned.
(9) The information processing apparatus according to any one of (1) to (8),
   wherein, when the rights information pre-assigned to the first content is acquired during the production of the second content, the acquisition unit displays a list of the rights information pre-assigned to the first content on a user interface that controls the production of the second content.
(10) The information processing apparatus according to (9),
   wherein, when the second content is produced by partially using the first content, the acquisition unit displays, on the user interface, a utilization fee to be paid by a producer of the second content to the right holder of the first content.
(11) The information processing apparatus according to (10),
   wherein the acquisition unit displays, as the utilization fee, a utilization fee individually set for a time length of use of the first content in the second content or individually set for each configuration of the first content.
(12) The information processing apparatus according to any one of (1) to (11),
   wherein the assignment unit assigns, as the rights information related to the second content, information indicating whether to permit secondary use, which is in a form of partially using the second content to produce third content being a new piece of content.
(13) The information processing apparatus according to (12),
   wherein the assignment unit assigns use conditions including a time length of use of the second content in the third content or a utilization fee individually set for each configuration of the second content.
(14) The information processing apparatus according to (13),
   wherein the acquisition unit acquires a distribution request of the second content from a copyright holder of the second content, and
   the assignment unit performs, in response to the distribution request acquired by the acquisition unit, distribution of the second content to which the information indicating whether the secondary use of the second content is permitted and the use condition, have been assigned.
(15) The information processing apparatus according to any one of (1) to (14),
   wherein the assignment unit registers rights information related to the second content to ledger data of a blockchain, which is constructed with at least one of a distributor of the second content, an administrator of the rights information assigned to the second content, and a collector who collects the utilization fee when the second content is used.
(16) An information processing method executed by a computer, the method comprising:
   acquiring rights information pre-assigned to first content; and
   performing, in a case where second content has been produced by partially using the first content, assignment of rights information related to the second content based on the rights information pre-assigned to the first content.
(17) An information processing program provided for causing a computer to function as:
   an acquisition unit that acquires rights information pre-assigned to first content; and
   an assignment unit that, in a case where second content has been produced by partially using the first content, assigns rights information related to the second content based on the rights information acquired by the acquisition unit.

### REFERENCE SIGNS LIST

1 INFORMATION PROCESSING SYSTEM

10 CREATOR TERMINAL

20 CREATOR

30 DISTRIBUTION AGENT

35 MUSIC PUBLISHER

40 COPYRIGHT ADMINISTRATOR

50 INFORMATION MANAGEMENT SYSTEM

100 INFORMATION PROCESSING APPARATUS

110 COMMUNICATION UNIT

120 STORAGE UNIT

121 CREATOR STORAGE UNIT

122 AUDIO SOURCE STORAGE UNIT

130 CONTROL UNIT

131 ACQUISITION UNIT

132 RECEPTION UNIT

133 GENERATION UNIT

134 ASSIGNMENT UNIT

200 USER TERMINAL

1. An information processing apparatus comprising:
an acquisition unit that acquires rights information pre-assigned to first content; and
an assignment unit that performs, in a case where second content has been produced by partially using the first content, assignment of rights information related to the second content based on the rights information acquired by the acquisition unit.

2. The information processing apparatus according to claim 1,
wherein the acquisition unit acquires, as the rights information pre-assigned to the first content, information related to permission and use conditions regarding secondary use that has been set in the first content, and
the assignment unit assigns, as the rights information related to the second content, information indicating that production of the second content using the first content is permitted.

3. The information processing apparatus according to claim 2,
wherein the acquisition unit acquires, as the rights information pre-assigned to the first content, information related to a plurality of right holders permitting secondary use of the first content, and
the assignment unit assigns, when the second content is produced, information indicating that an agreement has been obtained from the plurality of right holders permitting secondary use of the first content.

4. The information processing apparatus according to claim 1,
wherein the acquisition unit acquires, as the rights information pre-assigned to the first content, information related to permission and use conditions related to distribution of content produced by the secondary use of the first content, and
the assignment unit assigns, as the rights information related to the second content, information indicating that distribution of the second content is permitted.

5. The information processing apparatus according to claim 1,
wherein the acquisition unit acquires, as the rights information pre-assigned to the first content, information related to a right holder having a copyright related to the first content, and
the assignment unit assigns, as the rights information related to the second content, information related to a right holder having a copyright related to the first content together with information relate to a right holder having a copyright related to the second content.

6. The information processing apparatus according to claim 1,
wherein the acquisition unit refers to the rights information pre-assigned to the first content, and acquires a different piece of first content to which an advantageous use condition is assigned compared with the use condition indicated in the rights information.

7. The information processing apparatus according to claim 6,
wherein the acquisition unit refers to information related to a utilization fee in a case where the second content is produced by partially using the first content, as the rights information pre-assigned to the first content, and acquires the different piece of first content to which a utilization fee lower than the utilization fee is assigned.

8. The information processing apparatus according to claim 1,
wherein the acquisition unit refers to history information indicating the use of the first content at past production of the second content, and acquires a different piece of first content to which history information indicating higher use history is assigned.

9. The information processing apparatus according to claim 1,
wherein, when the rights information pre-assigned to the first content is acquired during the production of the second content, the acquisition unit displays a list of the rights information pre-assigned to the first content on a user interface that controls the production of the second content.

10. The information processing apparatus according to claim 9,
wherein, when the second content is produced by partially using the first content, the acquisition unit displays, on the user interface, a utilization fee to be paid by a producer of the second content to the right holder of the first content.

11. The information processing apparatus according to claim 10,
wherein the acquisition unit displays, as the utilization fee, a utilization fee individually set for a time length of use of the first content in the second content or individually set for each configuration of the first content.

12. The information processing apparatus according to claim 1,
wherein the assignment unit assigns, as the rights information related to the second content, information indicating whether to permit secondary use, which is in a form of partially using the second content to produce third content being a new piece of content.

13. The information processing apparatus according to claim 12,
wherein the assignment unit assigns use conditions including a time length of use of the second content in the third content or a utilization fee individually set for each configuration of the second content.

14. The information processing apparatus according to claim 13,
wherein the acquisition unit acquires a distribution request of the second content from a copyright holder of the second content, and
the assignment unit performs, in response to the distribution request acquired by the acquisition unit, distribution of the second content to which the information indicating whether the secondary use of the second content is permitted and the use condition, have been assigned.

15. The information processing apparatus according to claim 1,
wherein the assignment unit registers rights information related to the second content to ledger data of a blockchain, which is constructed with at least one of a distributor of the second content, an administrator of the rights information assigned to the second content, and a collector who collects the utilization fee when the second content is used.

16. An information processing method executed by a computer, the method comprising:
acquiring rights information pre-assigned to first content; and
performing, in a case where second content has been produced by partially using the first content, assignment of rights information related to the second content based on the rights information pre-assigned to the first content.

17. An information processing program provided for causing a computer to function as:
an acquisition unit that acquires rights information pre-assigned to first content; and
an assignment unit that, in a case where second content has been produced by partially using the first content, assigns rights information related to the second content based on the rights information acquired by the acquisition unit.
